(19) United States
(12) Patent Application Publication
(10) Pub. No.: US 2024/0105956 A1
(43) Pub. Date: Mar. 28, 2024

(54) GRAPHENE DISPERSION LIQUID AND POSITIVE ELECTRODE PASTE

(71) Applicant: Toray Industries, Inc., Tokyo (JP)

(72) Inventors: Tomohiro Kato, Otsu-shi, Shiga (JP); Takashi Takeuchi, Otsu-shi, Shiga (JP); Fumiya Katase, Otsu-shi, Shiga (JP); Eiichiro Tamaki, Otsu-shi, Shiga (JP)

(73) Assignee: Toray Industries, Inc., Tokyo (JP)

(21) Appl. No.: 17/769,029

(22) PCT Filed: Nov. 6, 2020
(86) PCT No.: PCT/JP2020/041528

§ 371 Date: Apr. 14, 2022

(30) Foreign Application Priority Data
Nov. 15, 2019 (JP) 2019-206892
Nov. 15, 2019 (JP) 2019-206893

(51) Int. Cl. H01M 4/62; C01B 32/194

(52) U.S. Cl. CPC H01M 4/625; C01B 32/194; H01M 2004/028

(57) ABSTRACT

A graphene dispersion liquid containing graphene and a solvent, wherein the graphene has an average thickness of 0.3 nm or more and 10 nm or less, wherein the solvent has a solubility parameter δ of 18 MPa^{0.5} or more and 28 MPa^{0.5} or less, and wherein the graphene dispersion liquid has a viscosity of 10,000 mPa·s or less at a graphene concentration adjusted to 3 weight %, at a shear rate of 10 sec⁻¹, and at a temperature of 25° C. Provided are: a graphene dispersion liquid that has excellent fluidity and dispersibility, and affords a coating film having excellent coating film uniformity; and a positive electrode paste that makes it possible to enhance the coating film uniformity and the battery life by virtue of the graphene dispersion liquid.

### CROSS REFERENCE TO RELATED APPLICATIONS

This is the U.S. National Phase application of PCT/JP2020/041528, filed Nov. 6, 2020, which claims priority to Japanese Patent Application No. 2019-206892, filed Nov. 15, 2019 and Japanese Patent Application No. 2019-206893, filed Nov. 15, 2019, the disclosures of each of these applications being incorporated herein by reference in their entireties for all purposes.

### FIELD OF THE INVENTION

The present invention relates to a graphene dispersion liquid, a method of producing the same, and a positive electrode paste.

### BACKGROUND OF THE INVENTION

In recent years, studies have actively been made on a graphene dispersion liquid and a graphene-containing film, and the utilization thereof for electroconductive inks, wiring materials, antistatic films, thermally conductive films, barrier films, and electroconductive additives for lithium-ion batteries has been under consideration.

In these applications, a graphene dispersion liquid is desired to have a higher fluidity, but a graphene dispersion liquid tends to have a higher viscosity, and hence needs to be diluted in order to have a higher fluidity, thus having difficulty in having an increased solid content. In addition, graphene tends to agglomerate in a graphene dispersion liquid, thus making the coating film uniformity insufficient in some cases. Because of this, it is necessary to enhance the dispersibility of graphene. One example that has been disclosed is a nanocarbon dispersion liquid that contains a nanocarbon substance, an organic solvent, and a polymer dispersant, and that has the nanocarbon substance dispersed in the organic solvent (see, for example, Patent Document 1). Another example that has been disclosed is a dispersion containing carbon nanotubes and graphene platelets (see, for example, Patent Document 2).

On the other hand, a lithium-ion battery to be used for a mobile device, electric vehicle, household electricity storage system, or the like is desired to undergo a smaller decrease in the battery capacity even through repeated cycles of charge and discharge, and to have an enhanced battery life.

One means therefor is to use graphene as an electroconductive additive. One example of a technology using an electroconductive additive is disclosed, in which an electrode for a secondary battery has a mixture layer containing: an active material for a secondary battery; and graphene, wherein the graphene content of the mixture layer and the porosity of the mixture layer are prescribed (see, for example, Patent Document 3).

### PATENT DOCUMENTS

Patent Document 1: Japanese Patent Laid-Open Publication No. 2019-19155
Patent Document 2: Japanese Patent Laid-open Publication No. 2014-525981
Patent Document 3: Japanese Patent Laid-Open Publication No. 2018-174134

### SUMMARY OF THE INVENTION

However, the dispersion liquids described in Patent Documents 1 and 2 have a problem in that the fluidity and dispersibility of graphene are still insufficient.

On the other hand, examples of applications that are affected by a problem related to the fluidity and dispersion properties of a graphene dispersion liquid include lithium-ion batteries, as above-mentioned. For a positive electrode paste to be used to produce a positive electrode for a lithium-ion battery, it is preferable that the positive electrode paste has a higher solid content. Accordingly, it is important that the concentration of the electroconductive additive is as high as possible, and that the viscosity of the electroconductive additive is as suitable as possible for mixing. Additionally, to enhance the battery life of a lithium-ion battery, it is important to inhibit the electrically conductive paths from being deteriorated by repeated cycles of charge and discharge. To achieve this, it is conceivably important that an electroconductive additive for forming electrically conductive paths is uniformly mixed with another material constituting a positive electrode paste, for example, a positive electrode active material or the like to form a uniform and stable coating film. For these reasons, a graphene dispersion liquid to be used to produce a positive electrode paste is desired to have high graphene dispersion properties and a viscosity suitable for mixing.

That electrode for a secondary battery which is described in Patent Document 3 can contain graphene, and thus be made less likely to cause pores. In recent years, however, there has been a demand for further enhancement of the battery life. In addition, there has been a demand for a graphene dispersion liquid the viscosity of which is high, and the fluidity of which is enhanced.

In view of this, a problem to be addressed by the present invention is to provide a graphene dispersion liquid that has excellent fluidity and dispersion properties, and affords a coating film having excellent coating film uniformity, and to provide a positive electrode paste that makes it possible to enhance the coating film uniformity and the battery life by virtue of the graphene dispersion liquid.

To solve the above-mentioned problems, the present invention according to exemplary embodiments provides a graphene dispersion liquid containing graphene and a solvent, wherein the graphene has an average thickness of 0.3 nm or more and 10 nm or less, wherein the solvent has a solubility parameter δ of 18 MPa^{0.5} or more and 28 MPa^{0.5} or less, and wherein the graphene dispersion liquid has a viscosity of 10,000 mPa·s or less at a graphene concentration adjusted to 3 weight %, at a shear rate of 10 sec⁻¹, and at a temperature of 25° C.

A graphene dispersion liquid according to the present invention has excellent fluidity and excellent graphene dispersion properties. In particular, when utilized as an electroconductive additive for a lithium-ion battery and mixed with a positive electrode active material, the graphene dispersion liquid according to the present invention has excellent graphene uniformity. In addition, a positive electrode paste according to the present invention has excellent coating film uniformity, and makes it possible to increase the solid content, and to enhance the battery life.

### DETAILED DESCRIPTION OF EMBODIMENTS OF THE INVENTION

First, a graphene dispersion liquid according to the present invention will be described. A graphene dispersion liquid according to embodiments of the present invention contains graphene having an average thickness of 0.3 nm or more and 10 nm or less and a solvent.

A thin sheet of graphene having an average thickness of 0.3 nm or more and 10 nm or less is flexible, accordingly conforms well to the surface of an object to be coated, and more easily forms a coating film having excellent electrical conductivity and thermal conductivity. On the other hand, thin graphene is more likely to agglomerate, and hence, use of such thin graphene conventionally makes it difficult to maintain the dispersibility in the graphene dispersion liquid. In addition, such a dispersion liquid tends to have a higher viscosity and an insufficient fluidity, resulting in decreased coating film uniformity in some cases. In addition, using such a dispersion liquid for a positive electrode paste poses a problem, for example, in that such a decrease in coating film uniformity decreases the battery life, or in that it is difficult to increase the solid content of the positive electrode paste.

The present invention can provide a dispersion liquid having excellent fluidity, wherein the dispersion liquid contains such thin graphene and a solvent having a solubility parameter δ of 18 MPa^{0.5} or more and 28 MPa^{0.5} or less, and thus, has a viscosity of 10,000 mPa·s or less at a graphene concentration adjusted to 3 weight %, at a shear rate of 10 sec⁻¹, and at a temperature of 25° C.

The solubility parameter δ, contrived by Hildebrand, is an index of solubility between a solvent and a solute. The smaller the difference 6 between the solvent and the solute, the larger the solubility. In cases where graphene has low solubility, the graphene precipitates, resulting in having a decreased dispersibility, but the dispersion liquid has a decreased viscosity. Conversely, graphene having high solubility has an increased dispersibility, but the dispersion liquid has an increased viscosity. That is, a graphene dispersion liquid has a trade-off relationship between viscosity and dispersibility. A graphene dispersion liquid having a graphene concentration adjusted to 3 weight % has a clayish form having no fluidity and having a viscosity of more than 10,000 mPa·s at a shear rate of 10 sec⁻¹ and at a temperature of 25° C.

The present invention can provide a graphene dispersion liquid having excellent fluidity despite use of thin graphene. Using a graphene dispersion liquid according to the present invention for a positive electrode paste or a positive electrode of a lithium-ion battery makes it easier to obtain a uniform coating film in which the positive electrode active material and the graphene dispersion liquid having a high fluidity are mixed uniformly, and makes it possible to enhance the solid content of the positive electrode paste. Furthermore, using such a graphene dispersion liquid leads to strengthening the bonding of the positive electrode in a lithium-ion battery, thus inhibits the electrically conductive paths from being deteriorated by repeated cycles of charge and discharge, and makes it possible to enhance the battery life.

A graphene dispersion liquid according to embodiments of the present invention contains a solvent having a solubility parameter δ of 18 MPa^{0.5} or more and 28 MPa^{0.5} or less. Containing a solvent having a solubility parameter δ within such a range enables the graphene to have an increased dispersibility and fluidity. Having a solubility parameter δ of less than 18 MPa^{0.5} or more than 28 MPa^{0.5} results in having a solubility insufficient for graphene, thus decreasing the fluidity and dispersibility and decreasing the coating film uniformity. In addition, having such a solubility parameter δ leads to decreasing the solid content of the positive electrode paste, and decreasing the battery life. The solvent preferably has a solubility parameter δ of 19 MPa^{0.5} or more, more preferably 20 MPa^{0.5} or more. On the other hand, the solvent preferably has a solubility parameter δ of 27 MPa^{0.5} or less, more preferably 26 MPa^{0.5} or less.

In the present invention, the values each used as the solubility parameter δ of the solvent is the ones listed in Table V in ALLAN F. M. BARTON, Chemical Reviews, 1975, Vol. 75, No. 6, 731-753. For a solvent not mentioned in the document, the solubility parameter δ can be calculated from δ={(ΔH−RT)/V}^{0.5} using the molar heat of evaporation ΔH, molar volume V, gas constant R, and temperature T (25° C. or 298.15 K) of the solvent in accordance with the definition of the Hildebrand solubility parameter.

Examples of solvents having a solubility parameter δ of 18 MPa^{0.5} or more and 28 MPa^{0.5} or less include toluene (δ=18.2), styrene (δ=19.0), o-xylene (δ=18.0), ethylbenzene (δ=18.0), tetrahydronaphthalene (δ=19.4), dichloromethane (δ=19.8), chloroform (δ=19.8), chlorobenzene (δ=19.4), furan (δ=19.2), tetrahydrofuran (δ=18.6), 1,4-dioxane (δ=20.5), acetone (δ=20.3), methylethylketone (δ=19.0), cyclohexanone (δ=20.3), diethylketone (δ=18.0), isophorone (δ=18.6), acetaldehyde (δ=21.1), furfural (δ=22.9), benzaldehyde (δ=19.2), γ-butyrolactone (δ=25.8), methyl acetate (δ=19.6), ethyl acetate (δ=18.6), acetonitrile (δ=24.3), acrylonitrile (δ=21.5), nitromethane (δ=26.0), nitrobenzene (δ=20.5), pyridine (δ=21.9), morpholine (δ=22.1), N-methylpyrrolidone (δ=23.1), quinoline (δ=22.1), N,N-dimethylformamide (δ=24.8), N,N-dimethylacetoamide (δ=22.1), dimethylsulfoxide (δ=24.5), ethanol (δ=26.0), 1-propanol (δ=24.3), 2-propanol (δ=23.5), 1-butanol (δ=23.3), 2-butanol (δ=22.1), benzyl alcohol (δ=22.1), ethyl lactate (δ=20.5), n-butyl lactate (δ=19.2), and the like. It is possible to use two or more kinds of these. In cases where two or more kinds of solvents are used, the 6 value of the solvent mixture is the sum of the values each obtained by multiplying the 6 value of each solvent by the molar ratio of the solvent. Among these, more preferable solvents are solvents having a solubility parameter δ of 20 MPa^{0.5} or more and 26 MPa^{0.5} or less which are selected from 1,4-dioxane (δ=20.5), acetone (δ=20.3), cyclohexanone (δ=20.3), acetaldehyde (δ=21.1), furfural (δ=22.9), γ-butyrolactone (δ=25.8), acetonitrile (δ=24.3), acrylonitrile (δ=21.5), nitromethane (δ=26.0), nitrobenzene (δ=20.5), pyridine (δ=21.9), morpholine (δ=22.1), N-methylpyrrolidone (δ=23.1), quinoline (δ=22.1), N,N-dimethylformamide (δ=24.8), N,N-dimethylacetoamide (δ=22.1), dimethylsulfoxide (δ=24.5), ethanol (δ=26.0), 1-propanol (δ=24.3), 2-propanol (δ=23.5), 1-butanol (δ=23.3), 2-butanol (δ=22.1), benzyl alcohol (δ=22.1), and ethyl lactate (δ=20.5). Still more preferable solvents are solvents having a solubility parameter δ of 21 MPa0.5 or more and 25 MPa0.5 or less which are selected from acetaldehyde (δ=21.1), furfural (δ=22.9), acetonitrile (δ=24.3), acrylonitrile (δ=21.5), nitromethane (δ=26.0), nitrobenzene (δ=20.5), pyridine (δ=21.9), morpholine (δ=22.1), N-methylpyrrolidone (δ=23.1), quinoline (δ=22.1), N,N-dimethylformamide (δ=24.8), N,N-dimethylacetoamide (δ=22.1), dimethylsulfoxide (δ=24.5), 1-propanol (δ=24.3), 2-propanol (δ=23.5), 1-butanol (δ=23.3), 2-butanol (δ=22.1), and benzyl alcohol (δ=22.1).

In particular, in lithium-ion battery applications, solvents selected from N,N-dimethylformamide, N-methylpyrrolidone, and N,N-dimethylacetoamide are preferable from the viewpoint of affinity with a binder polymer solution. It is possible to contain two or more kinds of these. Among these, N-methylpyrrolidone is more preferable from the viewpoint of more effectively achieving the effect of enhancing the dispersibility using a surface treatment agent. The solvation of N-methylpyrrolidone with the surface treatment agent attached to the graphene makes it possible to further enhance the dispersibility and fluidity.

A solvent for a graphene dispersion liquid according to the present invention can be easily identified as follows: the dispersion liquid is filtrated to remove the solid components, and the filtrate is analyzed by GC-MS.

A graphene dispersion liquid according to the present invention preferably has a low viscosity from the viewpoint of fluidity. The viscosity of the graphene dispersion liquid depends on the concentration of graphene, and hence, in the present invention, the viscosity at a graphene concentration adjusted to 3 weight % is selected as an index of viscosity, and the viscosity is measured at a shear rate of 10 sec⁻¹, which is just suitable for the liquid to dribble by its own weight, and at a temperature of 25° C.

As above-mentioned, thin graphene tends to have a higher viscosity. A conventional dispersion liquid containing graphene at 3 weight % often has a viscosity of more than 10,000 mPa·s. With such a viscosity, a positive electrode active material and graphene, for example, when used for a positive electrode paste, are not sufficiently mixed, resulting in decreasing the coating film uniformity, the solid content of the paste, and the battery life. A graphene dispersion liquid according to embodiments of the present invention contains the above-mentioned solvent to thereby have an increased fluidity, and has a viscosity of 10,000 mPa·s or less at a graphene concentration adjusted to 3 weight %, at a shear rate of 10 sec¹, and at a temperature of 25° C., thereby making it possible to enhance the coating film uniformity, to increase the solid content of the positive electrode paste, and to enhance the battery life. The viscosity of the graphene dispersion liquid at a shear rate of 10 sec⁻¹ is preferably 5,000 mPa·s or less, more preferably 3,000 mPa·s or less, still more preferably 1,000 mPa·s or less. From the viewpoint of easy coating, the viscosity of the graphene dispersion liquid is preferably 10 mPa·s or more, more preferably 20 mPa·s or more, still more preferably 50 mPa·s or more. Here, the viscosity of the graphene dispersion liquid is measured using a Brookfield viscometer LVDVII+ at 25° C. under conditions with rotor No. 6 and at 1/s=10.

In this regard, the viscosity of the graphene dispersion liquid can be adjusted within the above-mentioned range, for example, by using the above-mentioned preferable solvent and the below-mentioned polymer additive or adjusting the N/C ratio of the graphene within the below-mentioned preferable range.

<Graphene>

Graphene used as an electroconductive additive has a thin layer form, has many electrically conductive and thermally conductive paths per unit weight, forms a good electrically conductive and thermally conductive network in the coating film, and hence is useful. In addition, graphene is molecules having an impermeable thin layer form, thus makes it possible to decrease the substance-permeability of the coating film, and hence is useful also as a barrier film.

Graphene, in a narrow sense, refers to a sheet of sp²-bonded carbon atoms (single-layer graphene) with a thickness of one atom, but in the present specification, those having a flaky form in which single-layer graphenes are laminated are also called graphene. Similarly, graphene oxide is also a designation including those having a laminated flaky form.

In addition, graphene oxide, as mentioned in the present specification, has an O/C ratio of more than 0.4, which is an atomic ratio of oxygen atoms to carbon atoms, as measured by X-ray photoelectron spectroscopy (XPS), and what is referred to as graphene has the ratio at 0.4 or less. In addition, graphene also refers to reduced graphene oxide that is obtained by reducing graphene oxide, and has an O/C ratio of 0.4 or less.

Furthermore, there are some cases in which graphene or graphene oxide is surface-treated for the purpose of having an enhanced dispersibility or for another purpose. In the present specification, such graphene or graphene oxide having a surface treatment agent attached thereto is referred to as “graphene” or “graphene oxide”.

Graphene to be used for a graphene dispersion liquid according to embodiments of the present invention has an average thickness of 0.3 nm or more and 10 nm or less. A graphene dispersion liquid according to embodiments of the present invention is produced using thin graphene having an average thickness in such a range, thereby making it possible to maintain the electrical conductivity, and at the same time, enhance the conformability of the graphene to the surface of the positive electrode active material, and to facilitate the formation of electrically conductive paths. As the average thickness of graphene, 0.3 nm is theoretically the smallest value for graphene, and implies a single-layer graphene. On the other hand, graphene having an average thickness of more than 10 nm decreases the dispersibility and decreases the coating film uniformity. In addition, having such an average thickness decreases the conformability to the surface of the positive electrode active material, thus causing the electrically conductive paths to be formed insufficiently and shortening the battery life. The graphene preferably has an average thickness of 8 nm or less, more preferably 6 nm or less, from the viewpoint of further enhancing the fluidity of the positive electrode paste to facilitate increasing the solid content, from the viewpoint of further enhancing the coating film uniformity, and from the viewpoint of more effectively forming the electrically conductive paths to further enhance the battery life. Here, the average thickness of graphene in the graphene dispersion liquid can be determined as follows: graphene is taken out of the graphene dispersion liquid, and observably magnified into an approximately 1 to 10 μm square field-of-view range using an atomic force microscope so that the graphene can be observed suitably; 10 pieces of graphene are randomly selected; the thickness of each piece is measured; and the arithmetic average value is calculated. In this regard, the thickness of each piece of graphene is the arithmetic average of the values obtained by measuring the thicknesses of five points selected randomly from each piece of graphene.

The size of the graphene in the direction parallel to the graphene layer is preferably 0.1 μm or more, more preferably 0.5 μm or more, still more preferably 1 m or more, from the viewpoints of enhancing the coating film uniformity of the positive electrode paste, increasing the contact area with the positive electrode active material, and further enhancing the battery life. On the other hand, the size of graphene in the direction parallel to the graphene layer is preferably 100 μm or less, more preferably 50 μm or less, still more preferably 20 μm or less, from the viewpoints of further enhancing the dispersibility and enhancing the fluidity of the positive electrode paste to thereby facilitate increasing the solid content, and from the viewpoint of further enhancing the coating film uniformity. Here, the size of graphene in the direction parallel to the graphene layer in the graphene dispersion liquid can be determined as follows: graphene is taken out of the graphene dispersion liquid, and observably magnified at a magnification ratio of 1,500 to 50,000× using an electron microscope so that the graphene can be suitably positioned within a field-of-view; 10 pieces of graphene are selected randomly; the length of the longest portion (major axis) and the length of the shortest portion (minor axis) in the direction parallel to the graphene layer are each measured; and the arithmetic average of the measured values is calculated in accordance with (the major axis+the minor axis)/2. In this regard, the size of graphene in the direction parallel to the graphene layer can be easily adjusted within the above-mentioned range by using the below-mentioned method to comminute the graphene oxide or reduced graphene. Alternatively, it is possible to use commercially available graphene oxide or graphene having a desired size.

The element ratio of oxygen to carbon (O/C ratio) in graphene, as measured by X-ray photoelectron spectroscopy, is preferably 0.05 or more, more preferably 0.07 or more, still more preferably 0.08 or more, from the viewpoints of further enhancing the dispersibility by virtue of the remaining functional group, and further enhancing the coating film uniformity of the positive electrode paste. On the other hand, the O/C ratio is preferably 0.35 or less, more preferably 0.20 or less, still more preferably 0.15 or less, from the viewpoint of further enhancing the fluidity of the graphene dispersion liquid, and from the viewpoints of restituting the 71-electron-conjugated structure through reduction to further enhance the electrical conductivity, and further enhancing the coating film uniformity and the battery life. Here, the O/C ratio of graphene in the graphene dispersion liquid can be measured by X-ray photoelectron spectroscopy (XPS) using the graphene taken out of the graphene dispersion liquid. A C1s main peak originating from carbon atoms is assigned to a peak near 284.3 eV, an O1s peak originating from oxygen atoms is assigned to a peak near 533 eV, the O/C ratio is calculated from the area ratios between the peaks, and the calculated value is rounded off to two decimal places. In this regard, the O/C ratio of the graphene can be easily adjusted within the above-mentioned range, for example, using a chemical exfoliation method, in which case the degree of oxidation of the graphene oxide as a raw material is adjusted, and/or the degree of reduction is adjusted in accordance with the reduction reaction conditions. Alternatively, it is possible to use commercially available graphene oxide or graphene having a desired O/C ratio.

As above-mentioned, graphene or graphene oxide is surface-treated in some cases. In particular, a surface treatment agent containing nitrogen atoms tends to enhance the dispersibility of graphene in a solvent the below-mentioned solubility parameter δ of which is in the range of 18 MPa^{0.5} or more and 28 MPa^{0.5} or less. Furthermore, such a surface treatment agent makes it possible to enhance the interaction with the below-mentioned polyvinyl alcohol, to further enhance the dispersibility enhancement effect, and in addition, to further enhance the bonding force when used for a positive electrode of a lithium-ion battery.

In cases where graphene is treated with a surface treatment agent containing nitrogen atoms, the amount of the surface treatment agent attached to the graphene can be determined from the atomic ratio of nitrogen to carbon (N/C ratio) measured by X-ray photoelectron spectroscopy. The N/C ratio of the graphene is preferably 0.005 or more, more preferably 0.006 or more, still more preferably 0.008 or more, from the viewpoints of further enhancing the dispersibility, further enhancing the fluidity of the graphene dispersion liquid and the coating film uniformity of the positive electrode paste, and further enhancing the battery life. On the other hand, the N/C ratio of the graphene is preferably 0.020 or less, more preferably 0.018 or less, still more preferably 0.016 or less, from the viewpoint of further enhancing the fluidity of the graphene dispersion liquid and from the viewpoints of further enhancing the electrical conductivity and further enhancing the battery life and the coating film uniformity. Here, the N/C ratio of graphene in the graphene dispersion liquid can be measured by X-ray photoelectron spectroscopy (XPS) using the graphene taken out of the graphene dispersion liquid. A C1s main peak originating from carbon atoms is assigned to a peak near 284.3 eV, an N1s peak originating from nitrogen atoms is assigned to a peak near 402 eV, the N/C ratio is calculated from the area ratios between the peaks, and the calculated value is rounded off to three decimal places. In this regard, the N/C ratio of the graphene can be easily adjusted within the above-mentioned range, for example, in accordance with the attachment amount of the below-mentioned surface treatment agent.

The surface treatment agent is attached to the surface of the graphene to achieve the effect of further enhancing the dispersibility of the graphene. In the present specification, such graphene having a surface treatment agent attached thereto is referred to as “surface-treated graphene”. In embodiments of the present invention, that a surface treatment agent exists, attached to graphene means the following: a washing step is repeated five times or more, in which step, surface-treated graphene is dispersed in water 100 times more by mass, and filtrated; and then the resulting dispersion liquid is freeze-dried, and dried by a method such as spray-drying, whereafter the surface treatment agent remains in the surface-treated graphene. That the surface treatment agent remains means that the surface treatment agent molecule can be detected in the form of a protonated molecule on a positive secondary ion spectrum obtained by measuring the dried surface-treated graphene by time-of-flight secondary ion mass spectrometry (TOF-SIMS). However, in cases where the surface treatment agent is a neutralized salt, such a surface treatment agent can be detected in the form of a surface treatment agent molecule from which an anion molecule is removed, and to which a proton is added. The chemical structure of the surface treatment agent contained in the surface-treated graphene can be identified by TOF-SIMS. In this regard, the surface treatment agent is quantitated as follows: a washing step is repeated five times or more, in which step, surface-treated graphene is dispersed in water 100 times more by mass, and filtrated; and then, a sample obtained by freeze-drying the resulting dispersion is used.

As the surface treatment agent, a compound having an aromatic ring is preferable from the viewpoint of easily adsorbing on the graphene surface.

In addition, the surface treatment agent preferably has an acidic group and/or a basic group.

The acidic group is preferably a group selected from a hydroxy group, a phenolic hydroxy group, a nitro group, a carboxyl group and a carbonyl group. It is possible to use two or more kinds thereof. Among these, a phenolic hydroxy group is preferable.

Examples of compounds having a phenolic hydroxy group and an aromatic ring include phenol, nitrophenol, cresol, and catechol. Part of the hydrogens of any of these compounds may be substituted. Among these, catechol and derivatives thereof are preferable from the viewpoint of the adhesiveness to graphene and the dispersibility in a dispersion medium. Preferable examples include catechol, dopamine hydrochloride, 3-(3,4-dihydroxyphenyl)-L-alanine, 4-(1-hydroxy-2-aminoethyl)catechol, 3,4-dihydroxy benzoic acid, 3,4-dihydroxyphenyl acetic acid, caffeic acid, 4-methyl catechol, and 4-tert-butyl pyrocatechol.

Preferable examples of basic groups include amino groups.

Examples of compounds having an amino group and an aromatic ring include benzylamine, phenylethylamine, and salts thereof. Part of the hydrogens of any of these compounds may be substituted.

Compounds having an acidic group, a basic group, and an aromatic ring are also preferable, and, for example, dopamine hydrochloride or the like is preferable.

Graphene to be used in the present invention may be produced by a physical exfoliation method, or may be produced by a chemical exfoliation method. Graphene oxide to be produced by a chemical exfoliation method is not limited to any particular production method, and a known method such as the Hummers' method can be used. Alternatively, it is possible to purchase commercially available graphene oxide.

The chemical exfoliation method preferably has a step of oxidation-exfoliating graphite to obtain graphene oxide (a graphite exfoliation step) and a step of reduction (a reduction step) in this order. If needed, it is possible to perform, between the graphite exfoliation step and the reduction step, a step of attaching a surface treatment agent to graphene (a surface-treatment step) and/or a step of adjusting the size of graphene in the direction parallel to the graphene layer (a comminuting step). In cases where a surface-treated graphene is attached to graphene, the surface treatment agent may be attached to the graphene after the reduction step, or the reduction step may be performed after the surface treatment agent is attached to graphene oxide. Additionally, in cases where graphene is comminuted, graphene oxide may be comminuted, or reduced graphene may be comminuted. From the viewpoint of the uniformity of the reduction reaction, the reduction step is preferably performed in a state where the graphene oxide is comminuted, that is, the comminuting step is preferably performed before the reduction step or during the reduction step. Accordingly, the graphite exfoliation step, the surface-treatment step, the comminuting step, and the reduction step are preferably performed in this order.

[Graphite Exfoliation Step]

First, graphite is oxidation-exfoliated to obtain graphene oxide. The degree of oxidation of graphene oxide can be adjusted by changing the amount of an oxidizing agent to be used for the oxidation reaction of graphite. Specific examples of oxidizing agents that can be used include sodium nitrate and potassium permanganate. The larger the amount of the oxidizing agent used with respect to the graphite during the oxidation reaction, the higher the degree of oxidation. The smaller the amount, the lower the degree of oxidation. The weight ratio of the sodium nitrate with respect to the graphite is preferably 0.200 or more and 0.800 or less. The weight ratio of the potassium permanganate with respect to the graphite is preferably 1.00 or more and 4.00 or less.

[Surface-Treatment Step]

Next, the graphene oxide and the surface treatment agent are mixed so that the surface treatment agent can be attached to the graphene. Examples of mixing methods include mixing methods using a mixer or a kneader, such as an automatic mortar, triple roll, beads mill, planetary ball mill, homogenizer, homodisper, homomixer, planetary mixer, two-screw kneader, or the like.

[Comminuting Step]

Next, the graphene oxide is comminuted. Examples of comminuting methods include: a method in which a pressurized dispersion liquid is collided against a single ceramic ball; a method performed using a liquid-liquid shear type wet jet mill which causes pressurized dispersion liquids to collide with each other for dispersion; a method in which ultrasonic waves are applied to a dispersion liquid; and the like. In the comminuting step, the higher the treatment pressure or the output is, or the longer the treatment time is, the more comminuted the graphene oxide or the graphene tends to be. The size of the reduced graphene can be adjusted in accordance with the kind, treatment condition, and treatment time of the comminution treatment in the comminuting step. In order to adjust the size parallel to the graphene layer within the above-mentioned range, the solid concentration of the graphene oxide or the graphene in the comminuting step is preferably 0.01 weight % or more and 2 weight % or less. In addition, in cases where an ultrasonic treatment is performed, the ultrasonic output is preferably 100 W or more and 3000 W or less.

[Reduction Step]

Next, the comminuted graphene oxide is reduced. A preferable reduction method is chemical reduction. In the case of chemical reduction, examples of reducing agents include organic reducing agents and inorganic reducing agents. Inorganic reducing agents are more preferable from the viewpoint of washing after reduction.

Examples of the organic reducing agent include an aldehyde reducing agent, a hydrazine derivative reducing agent, and an alcohol reducing agent. Among them, an alcohol reducing agent is particularly suitable because it can reduce graphene oxide relatively mildly. Examples of the alcohol reducing agent include methanol, ethanol, propanol, isopropyl alcohol, butanol, benzyl alcohol, phenol, ethanolamine, ethylene glycol, propylene glycol, diethylene glycol, and the like.

Examples of the inorganic reducing agent include sodium dithionite, potassium dithionite, phosphorous acid, sodium borohydride, hydrazine and the like. Among them, sodium dithionite or potassium dithionite is suitably used because they can reduce graphene oxide while relatively retaining acidic groups, so graphene having high dispersibility in a solvent can be produced.

After finishing the reduction step, the resulting graphene preferably undergoes a washing step including dilution with water and filtration so that the graphene can have an enhanced purity.

<Polymer Additive>

A graphene dispersion liquid according to the present invention preferably contains a polymer additive soluble in a solvent having a solubility parameter δ of 18 MPa^{0.5} or more and 28 MPa^{0.5} or less. Examples of polymer additives include polyvinyl alcohol, polyvinylpyrrolidone, carboxymethyl cellulose, hydroxyethyl cellulose, hydroxypropyl cellulose, and the like. Among these, polymer additives selected from polyvinyl alcohol, polyvinylpyrrolidone, and hydroxypropyl cellulose are more preferable from the viewpoints of enhancing the dispersibility and fluidity of graphene, and further enhancing the coating film uniformity. Polyvinyl alcohol or polyvinylpyrrolidone is still more preferable.

<Polyvinyl Alcohol>

For a graphene dispersion liquid according to the present invention, a polyvinyl alcohol having a specific saponification ratio is preferably used. An interaction, for example, hydrogen bonding between a hydroxyl group of the polyvinyl alcohol and an oxygen-containing functional group of the graphene and/or a functional group of the surface treatment agent makes it possible to further enhance the dispersibility and fluidity of the graphene, and in addition, to enhance the bonding force between the graphene and the polyvinyl alcohol. Accordingly, in the present invention, the hydroxyl group content of the polyvinyl alcohol, that is, the saponification ratio is important.

The saponification ratio of a polyvinyl alcohol to be used in a graphene dispersion liquid according to the present invention is preferably 70% or more and 100% or less. Bringing the saponification ratio within such a range makes it possible that the interaction with graphene further enhances the dispersibility. Binging the saponification ratio of the polyvinyl alcohol to 70% or more makes it possible that the interaction with graphene further enhances the dispersibility, and further enhances the fluidity and battery life of the graphene dispersion liquid. The saponification ratio of the polyvinyl alcohol is more preferably 75% or more, still more preferably 80% or more. On the other hand, from the viewpoint of enhancing the solubility of the polyvinyl alcohol in the organic solvent, the saponification ratio of the polyvinyl alcohol is preferably 99.9% or less, more preferably 98% or less. Here, the saponification ratio of the polyvinyl alcohol can be determined in accordance with JIS K 6726-1994. In addition, % as the saponification ratio means mol %.

The polyvinyl alcohol may be an unmodified polyvinyl alcohol or a modified polyvinyl alcohol.

Examples of unmodified polyvinyl alcohols include: tradename “KURARAY POVAL” (registered trademark) (Kuraray Co., Ltd.): tradename “GOHSENOL” (registered trademark) (Mitsubishi Chemical Corporation); tradename “DENKA POVAL” (registered trademark) (Denka Company Limited); tradename “J-POVAL” (Japan VAM & POVAL Co., Ltd.); and the like.

Examples of modified polyvinyl alcohols include modified polyvinyl alcohols the side chain of which has a group selected from a carboxyl group, sulfonic group, cationic group (quaternary ammonium salt), and ethylene oxide group. Specific examples include: tradename “GOHSENX” (registered trademark) K, L, T, and WO series (Mitsubishi Chemical Corporation); and the like.

In addition, the polymerization degree of the polyvinyl alcohol is preferably 100 or more, more preferably 200 or more, still more preferably 300 or more, from the viewpoint of obtaining the dispersibility enhancement effect. On the other hand, the polymerization degree of the polyvinyl alcohol is preferably 10,000 or less, more preferably 5,000 or less, still more preferably 2,000 or less, from the viewpoints of further enhancing the fluidity of the graphene dispersion liquid, enhancing the solid content of the positive electrode paste, and further enhancing the battery life. Here, the polymerization degree of the unmodified polyvinyl alcohol can be determined in accordance with JIS K 6726-1994.

It is possible to contain two or more kinds of polyvinyl alcohols. In such a case, it is preferable that the saponification ratio and polymerization degree of the whole two or more kinds of polyvinyl alcohols are each within the above-mentioned range.

<Polyvinylpyrrolidone>

A graphene dispersion liquid according to the present invention may contain polyvinylpyrrolidone. In the same manner as the above-mentioned polyvinyl alcohol, polyvinylpyrrolidone makes it possible that an interaction such as hydrogen bonding with the graphene enhances the dispersibility of the graphene in a solvent.

Polyvinylpyrrolidone that can be used is of a molecular weight grade such as K-15, K-30, K-60, K-90, or K-120. From the viewpoint of obtaining the effect of enhancing the dispersibility of graphene, K-15, K-30, and K-60 are more preferable, and K-15 and K-30 are still more preferable.

The polyvinylpyrrolidone may be a copolymer with an acrylic monomer other than vinylpyrrolidone. Examples of acrylic monomers other than vinylpyrrolidone include, but are not limited particularly to, vinyl acetate, hydroxyethyl methacrylate, acrylic acid, dimethylacrylamide, butyl acrylate, and the like.

<Cellulose Derivative>

A graphene dispersion liquid according to the present invention may contain a cellulose derivative such as carboxymethyl cellulose, hydroxyethyl cellulose, or hydroxypropyl cellulose. Among these, hydroxyethyl cellulose and hydroxypropyl cellulose are more preferable, and hydroxypropyl cellulose is still more preferable, from the viewpoint of having the excellent effect of enhancing the dispersibility of the graphene.

The mass-average molecular weight (Mw) of the cellulose derivative is preferably 1,000 or more, more preferably 5,000 or more, from the viewpoint of obtaining the effect of enhancing the dispersibility of graphene. In addition, the molecular weight is preferably 1,000,000 or less, more preferably 500,000 or less, from the viewpoint of affording an excellent solubility in a solvent.

A graphene dispersion liquid according to the present invention preferably contains 1 part by weight or more and 300 parts by weight or less of the above-mentioned polymer additive with respect to 100 parts by weight of the above-mentioned graphene. Containing the polymer additive in an amount of 1 part by weight or more makes it possible that the dispersibility enhancement effect of the polymer additive further enhances the fluidity of the graphene dispersion liquid, and further enhances the coating film uniformity and battery life of the positive electrode paste. The polymer additive is contained more preferably in an amount of 3 parts by weight or more, more preferably 5 parts by weight or more, more preferably 10 parts by weight or more, still more preferably 15 parts by weight or more, particularly preferably 20 parts by weight or more. On the other hand, containing the polymer additive in an amount of 300 parts by weight or less makes it possible to inhibit the electrical resistance of the coating film to be formed, and to further enhance the battery life. In addition, it is possible to further enhance the fluidity of the graphene dispersion liquid, and further enhance the solid content and coating film uniformity of the positive electrode paste. The polymer additive is contained more preferably in an amount of 200 parts by weight or less, still more preferably 100 parts by weight or less.

The amount of each of the graphene and the polymer additive contained in the graphene dispersion liquid according to the present invention can be determined by the below-mentioned method. First, the graphene and the polymer additive are separated by filtration. The residue containing the graphene is washed well using a solvent, the residue is then dried, and the graphene content can be determined. In addition, the solvent is distilled off from the filtrate (containing the polymer additive), the resulting residue is then dried, and measuring the weight of the resulting residue makes it possible to determine the polymer additive content. However, in cases where the composition of the raw material to be used for the graphene dispersion liquid is known, the content can be determined from the composition of the raw material by calculation.

In addition, the storage elastic modulus and loss elastic modulus of a graphene dispersion liquid according to the present invention are each preferably 0.1 Pa or more and 100 Pa or less at a graphene concentration adjusted to 3 weight %, at a strain of 10%, at a frequency of 10 Hz, and at a temperature of 25° C. The storage elastic modulus and the loss elastic modulus are important indexes from the viewpoint of examining the fluidity of the graphene dispersion liquid in detail. Having the storage elastic modulus and the loss elastic modulus within the above-mentioned range at a strain of 10% and at 10 Hz enables, for example, a flow in piping, and facilitates continuously supplying the graphene dispersion liquid according to embodiments of the present invention. In addition, graphene having such properties makes it possible to enhance the coating film uniformity, enhance the solid content of the positive electrode paste, and thus enhance the battery life. The storage elastic modulus and the loss elastic modulus of the dispersion liquid are each preferably 100 Pa or less, more preferably 80 Pa or less, still more preferably 60 Pa or less. From the viewpoint of easy coating, the moduli are each preferably 0.1 Pa or more, more preferably 0.2 Pa or more, still more preferably 0.5 Pa or more.

As above-mentioned, a conventional graphene dispersion liquid has a viscosity that increases markedly as the graphene concentration increases from 2 weight %. In many cases, such a graphene dispersion liquid is not liquid but clayish at a graphene concentration of 3 weight %, making it impossible to measure the viscosity, but a graphene dispersion liquid according to the present invention keeps liquid even at a graphene concentration of 3 weight %, which is a high concentration. The inventors have discovered that the graphene dispersion liquid according to embodiments of the present invention accordingly exhibits a low storage elastic modulus and loss elastic modulus at a strain of 10%, but at a given or more strain, for example, at a strain of 200%, produces a peculiar phenomenon in which collision between graphene particles causes an increase in the storage elastic modulus and the loss elastic modulus. On the other hand, a conventional graphene dispersion liquid that is clayish at a graphene concentration of 3 weight % exhibits a high storage elastic modulus and loss elastic modulus at a strain of 10%, and behaves in such a manner that, as the strain is increased, the structure collapses, during which the high storage elastic modulus and loss elastic modulus are gradually decreased. That is, that the storage elastic modulus and loss elastic modulus at a strain of 200% are larger than the storage elastic modulus and loss elastic modulus at a strain of 10% means that the graphene dispersion liquid has excellent fluidity. The storage elastic modulus and loss elastic modulus of a graphene dispersion liquid according to the present invention each preferably satisfy the following formula (1) and/or formula (2) at a graphene concentration adjusted to 3 weight %, at a frequency of 10 Hz, and at a temperature of 25° C.

G′₂₀₀/G′₁₀≥1 Formula (1):

In formula (1), G′₂₀₀ represents a storage elastic modulus at a strain of 200%, and G′₁₀ represents a storage elastic modulus at a strain of 10%.

G″₂₀₀/G″₁₀≥1 Formula (2):

In formula (2), G″₂₀₀ represents a loss elastic modulus at a strain of 200%, and G″₁₀ represents a loss elastic modulus at a strain of 10%.

From the viewpoint of excellent fluidity, G′₂₀₀/G′₁₀ and/or G″₂₀₀/G″ 10 is each preferably 1 or more, more preferably 10 or more, still more preferably 100 or more.

Here, the storage elastic modulus and loss elastic modulus of the dispersion liquid are measured at a frequency of 10 Hz and at a temperature of 25° C. in a nitrogen gas stream using a viscoelasticity measurement device ARES-G2 (manufactured by TA Instruments, Inc.) with a parallel circular plate geometry having a diameter of 40 mm.

In this regard, the storage elastic modulus and loss elastic modulus of the graphene dispersion liquid can be easily adjusted within the above-mentioned range, for example, by using the above-mentioned preferable solvent and polyvinyl alcohol, or adjusting the N/C ratio of the graphene within the above-mentioned preferable range.

A graphene dispersion liquid according to the present invention preferably has fluidity. In the present specification, having fluidity refers to the following: 1 g of graphene dispersion liquid is dropped in the form of a circle having a diameter of approximately 1 cm onto one end of the non-glossy side of a clean and flat aluminum foil having a width of 5 cm and a length of 15 cm; that side of the aluminum foil on which the graphene dispersion liquid has been placed is held and pulled up, whereby the aluminum foil is stood vertically; the aluminum foil is held without being vibrated, and left to stand for 10 minutes; and the distance down which the graphene dispersion liquid has dribbled by virtue of its own weight is 3 cm or more. The distance down which the graphene dispersion liquid has dribbled can be determined as follows: with respect to the end of the graphene dispersion liquid in the direction of the gravity applied with the aluminum foil stood vertically, the distance is measured before and after the graphene dispersion liquid dribbles. A larger distance down which the graphene dispersion liquid has dribbled means a higher fluidity. The distance down which the graphene dispersion liquid has dribbled by virtue of its own weight is more preferably 10 cm or more from the viewpoints of facilitating mixing the materials of the positive electrode paste, and further enhancing the battery life.

Next, a method of producing a graphene dispersion liquid according to embodiments of the present invention will be described. Examples of a method of producing a graphene dispersion liquid include: a method in which graphene powder or a graphene dispersion liquid is mixed with polyvinyl alcohol dissolved in the above-mentioned solvent; and the like. It is preferable to use a graphene dispersion liquid from the viewpoint of further inhibiting the agglomeration of graphene.

A preferable device for mixing a solution of the above-mentioned polymer additive with the graphene powder or the graphene dispersion liquid is a device that can apply a shearing force. Examples of such devices that can be used include planetary mixers, “FILMIX” (registered trademark) (Primix Corporation), rotary and revolutionary mixers, planetary ball mills, triple roll mills, and the like.

It is possible to use a high shear mixer to perform a strong stirring step for stirring at a shear rate of 5,000 per second to 50,000 per second. Exfoliation of graphene using a high shear mixer in the strong stirring step makes it possible to obviate stacking between graphene pieces, and to adjust the average thickness of the graphene. Preferable examples of high shear mixers include such mixers of a thin film spin type, rotor/stator type, or media mill type. Specific examples include “FILMIX” (registered trademark) model 30-30 (manufactured by PRIMIX Corporation), “CLEARMIX” (registered trademark) CLM-0.8S (manufactured by M Technique Co., Ltd.), “LABOSTAR” (registered trademark) MINILMZ015 (Ashizawa Finetech Ltd.), SUPER SHEAR MIXER SDRT 0.35-0.75 (manufactured by Satake Chemical Equipment Mfg., Ltd.), and the like. The shear rate in the strong stirring step is preferably 5,000 per second to 50,000 per second, as above-mentioned. Bringing the shear rate to 5,000 or more per second makes it possible to facilitate the exfoliation of graphene, and to easily adjust the average thickness of the graphene within the above-mentioned range. In addition, the treatment time for the strong stirring step is preferably 15 seconds to 300 seconds.

In particular, in cases where the viscosity of the graphene dispersion liquid is high before the above-mentioned polymer additive is added to the graphene dispersion liquid, mixing by use of a high shear mixer is difficult in some cases. In such a case, it is possible to use a propellerless rotary and revolutionary mixer. Examples of propellerless rotary and revolutionary mixers include: “AWATORI RENTARO” (registered trademark) manufactured by Thinky Corporation; and “KAKUHUNTER” (registered trademark) manufactured by Shashin Kagaku Co., Ltd. A treatment with such a mixer is performed preferably at a rotating speed of 2000 rpm for 5 minutes or more, more preferably 10 minutes or more, still more preferably 15 minutes or more.

Coating a base plate with the above-mentioned graphene dispersion liquid makes it possible to form a graphene-containing film. Examples of coating methods for the graphene dispersion liquid include a doctor blade method, dipping method, reverse roll method, direct roll method, gravure method, extrusion method, brushing method, spray coating method, inkjet method, flexographic method, and the like. Among these, a spraying method or a coater method is preferable from the viewpoint of easiness of application to a positive electrode paste and a positive electrode of a lithium-ion battery.

With a graphene dispersion liquid according to the present invention, an additive may be further mixed. Examples of additives include positive electrode active materials, binders, cross-linking agents, antidegradants, inorganic fillers, and the like.

A graphene dispersion liquid according to the present invention has excellent fluidity and graphene dispersion properties, and thus, can be suitably used, for example, for an electrically conductive film having excellent electrical conductivity, a heat-radiation resin having excellent thermal conductivity, a corrosion-resistant coating film having excellent barrier properties, and the like.

Next, a positive electrode paste according to the present invention will be described. A positive electrode paste according to the present invention contains the above-mentioned graphene dispersion liquid and positive electrode active material. If needed, the positive electrode paste may further contain an electroconductive additive other than graphene.

The positive electrode active material is a material that can electrochemically occlude and release lithium ions. Examples include: lithium manganate (LiMn₂O₄) having a spinel structure; lithium manganate (LiMnO₂) having a rock salt structure; lithium cobalt oxide (LiCoO₂); lithium nickel oxide (LiNiO₂); a ternary system having a partial substitution of nickel with manganese and cobalt (LiNiₓMn_{y}Co_{1-x-y} O₂); a ternary system having a partial substitution of nickel with cobalt and aluminum (LiNiₓCo_{y}Al_{1-x-y}O₂); metal oxide active materials such as V205; metal compound-based active materials such as TiS₂, MoS₂, and NbSe₂; lithium iron phosphate (LiFePO₄) having an olivin structure; lithium manganese phosphate (LiMnPO₄); solid solution-based active materials; and the like. It is possible to use two or more kinds of these. Among these, active materials containing lithium and nickel are preferable. Preferable examples of active materials containing lithium and nickel include; lithium nickel oxide (LiNiO₂); a ternary system having a partial substitution of nickel with manganese and cobalt (LiNiₓMn_{y}Co_{1-x-y}O₂); a ternary system having a partial substitution with cobalt and aluminum (LiNiₓCo_{y}Al_{1-x-y}O₂); and the like. These materials make it possible to enhance the energy density.

Furthermore, in cases where a positive electrode active material in the form of a granulated product is used, the graphene tends to conform to the rough surface of the positive electrode active material so that both can be in facial contact, and hence, in particular, the effects of the present invention are markedly achieved. The granulated product means spherical particles obtained, for example, by spraying and drying slurry in which powder is dispersed. Examples of a positive electrode active material to be used as a granulated product include a ternary system (LiNiₓMn_{y}Co_{1-x-y}O₂), LiNiₓCo_{y}Al_{1-x-y}O₂, and the like. A granulated product is composed of secondary particles formed from aggregation of primary particles, thus tends to have a rough surface, involves increasing the face at which the positive electrode active material and the electroconductive additive are in contact, and thus, enables the effects of the present invention to be achieved markedly.

The particle diameter of the positive electrode active material is preferably 20 m or less from the viewpoint of facilitating the above-mentioned formation of electrically conductive paths by the graphene. In the present specification, the particle diameter means a median diameter (Dso). The median diameter can be measured using a laser scattering particle size distribution measurement device (for example, Microtrac HRAX-100 manufactured by Nikkiso Co., Ltd.). Additionally, in the present specification, the “particle diameter of a positive electrode active material” means a secondary particle diameter in cases where the positive electrode active material is a granulated product.

A positive electrode paste according to the present invention preferably contains 0.05 part by weight or more and 2.5 parts by weight or less of the above-mentioned graphene with respect to 100 parts by weight of the positive electrode active material. Bringing the graphene content to 0.05 parts by weight or more makes it possible to increase the solid content of the positive electrode paste. The graphene content is preferably 0.1 part by weight or more, more preferably 0.2 part by weight or more. On the other hand, bringing the graphene content to 2.5 parts by weight or less makes it possible to facilitate the formation of electrically conductive paths, and to further enhance the battery life.

The amount of each of the positive electrode active material, the graphene, and the polymer additive contained in the positive electrode paste according to the present invention can be determined by the below-mentioned method. The solid component is taken out of a positive electrode paste by filtration, washed with a solvent, and then dried. The weight of the resulting dried powder is measured to determine the total weight of the positive electrode active material and the electroconductive additive. Furthermore, acid such as hydrochloric acid or nitric acid is used to dissolve the positive electrode active material in the solid component, and the resulting solution is filtrated to separate the electroconductive additive. The residue is washed with water, and then dried. Measuring the weight of the resulting residue makes it possible to measure the electroconductive additive content. In addition, the weight of the positive electrode active material can be determined from the total weight of the positive electrode active material and the electroconductive additive and the weight of the electroconductive additive. In cases where the electroconductive additives include graphene and a material other than graphene, the size of each electroconductive additive is determined from an SEM image of powder. Using a sieve so as to collect the graphene that has passed through the sieve or caught by the sieve makes it possible to determine the amount of the graphene alone. In cases where the plurality of electroconductive additives have approximately the same size, and where it is difficult to sieve, the amount of each electroconductive additive can be determined from the ratios of the cross-sectional areas in a surface SEM image of the powder. However, in cases where the composition of the raw material to be used for the positive electrode paste is known, the amount can be determined from the composition of the raw material by calculation.

A positive electrode paste according to the present invention may further contain a binder, an electroconductive additive other than graphene, or another additive.

Examples of binders include: fluorine-based polymers such as polyvinylidene fluoride (PVDF) and polytetrafluoroethylene (PTFE); rubbers such as styrene butadiene rubber (SBR) and natural rubber; polysaccharides such as carboxymethyl cellulose; polyimide precursors and/or polyimide resins; polyamideimide resins; polyamide resins; polyacrylic acids; sodium polyacrylate; acrylic resins; polyacrylonitrile; and the like. It is possible to contain two or more kinds of these.

The amount of a binder is preferably 0.2 part by weight or more and 2 parts by weight or less with respect to 100 parts by weight of the positive electrode active material. Bringing the amount of a binder to 0.2 parts by weight or more makes it possible to further enhance the battery life. On the other hand, bringing the amount of a binder to 2 parts by weight or less makes it possible to further enhance the fluidity of the positive electrode paste, and to further enhance the solid content. In this regard, a graphene dispersion liquid and positive electrode paste according to the present invention each form a self-supported film, have the property of holding the positive electrode active material, and thus, optionally contain no binder.

An electroconductive additive other than graphene preferably has high electron conductivity. Examples include: carbon materials such as carbon fiber, carbon black, acetylene black, carbon nanofiber, carbon nanotubes, and “VGCF” (registered trademark) -H (manufactured by Showa Denko K.K.); metal materials such as copper, nickel, aluminum, and silver; and the like. It is possible to contain two or more kinds of these. Among these, fibrous carbon nanofiber, carbon nanotubes, or “VGCF” (registered trademark) -H (manufactured by Showa Denko K.K.) are preferable, and make it possible to enhance the electrical conductivity of the electrode in the thickness direction.

The amount of an electroconductive additive other than graphene is preferably 0.1 part by weight or more and 2 parts by weight or less with respect to 100 parts by weight of the positive electrode active material. Bringing the amount of an electroconductive additive other than graphene to 0.1 part by weight or more makes it possible to further enhance the battery life. On the other hand, bringing the amount of an electroconductive additive other than graphene to 2 parts by weight or less makes it possible to further enhance the fluidity of the positive electrode paste, and to further enhance the solid content.

In a method of analyzing the constituent materials of the positive electrode paste and the composition ratios of the materials, the solid component is taken out of a positive electrode paste by filtration, washed with a solvent, and then dried. Then, an X-ray diffraction measurement of the resulting dried powder makes it possible to identify the kind of the positive electrode active material. In cases where two or more positive electrode active materials are mixed, a further analysis of the powder by energy dispersive X-ray spectroscopy or ICP-MS (inductively coupled plasma-mass spectroscopy) makes it possible to determine the mixing ratios of the positive electrode active materials. However, in cases where the composition of the raw material to be used for the positive electrode paste is known, the amount can be determined from the composition of the raw material by calculation.

In cases where an FT-IR measurement of the filtrate obtained by the above-mentioned filtration yields a spectrum in which C-F absorption derived from PVDF is observed, it can be judged that PVDF is contained as a binder. In addition, drying the filtrate, followed by measuring the weight, makes it possible to measure the amount of a binder contained in the positive electrode paste. In addition, redissolving the dried filtrate in a deuterated solvent, followed by analyzing the resulting solution using an NMR (nuclear magnetic resonance spectrometer), makes it possible to identify the other binder(s).

A positive electrode paste according to the present invention preferably has a viscosity of 1,800 mPa·s or more and 2,200 mPa·s or less at 25° C. from the viewpoint of suitability for coating. The paste that does not have a viscosity within this range is preferably mixed with a solvent so that the viscosity can be adjusted desirably. Here, the viscosity of the positive electrode paste at 25° C. can be measured using a Brookfield viscometer LVDVII+ under conditions with rotor No. 6 and at 60 rpm.

In the present specification, the solid content of the positive electrode paste refers to a value obtained as follows: a positive electrode paste has a viscosity adjusted so as to be 1,800 mPa·s or more and 2,200 mPa·s or less as measured by the above-mentioned measurement method; 1 g of the positive electrode paste is placed on a glass slide, and dried by heating in a vacuum oven at 120° C. for 5 hours; and the weight after drying is divided by the weight before drying.

The solid content of the positive electrode paste is preferably 70 weight % or more from the viewpoint of forming the electrically conductive paths and enhancing the battery life. A higher fluidity of the graphene dispersion liquid makes it possible to enhance the mixing state of the materials in the positive electrode paste, decrease the amount of the solvent to be used to adjust the viscosity, and enhance the solid content of the positive electrode paste.

Examples of methods of producing a positive electrode paste according to the present invention include a method in which the above-mentioned graphene dispersion liquid according to the present invention, positive electrode active material, and binder or binder solution are mixed at a desired ratio; and then, the viscosity is measured by the above-mentioned method; to the resulting mixture, a solvent is added so that the viscosity can be 1,800 mPa·s or more and 2,000 mPa·s or less; and then, the materials are mixed again. Examples of such a solvent include the solvents enumerated for the graphene dispersion liquid. Before the viscosity is adjusted, an electroconductive additive other than graphene, and (an)other additive(s) may be added.

Examples of mixing devices for the positive electrode paste include devices enumerated as those for mixing a polyvinyl alcohol solution with graphene powder or a dispersion liquid.

A positive electrode paste according to the present invention is suitably used for a positive electrode of a lithium-ion battery. It is preferable that a dried film of the positive electrode paste is on a current-collecting foil.

A material constituting the current-collecting foil is preferably aluminum or an alloy. Aluminum is stable in a positive electrode reaction atmosphere, and hence, high purity aluminums represented by JIS standards 1030, 1050, 1085, 1N90, 1N99, and the like are preferable. The current-collecting foil preferably has a thickness of 10 μm or more and 100 μm or less. Bringing the thickness of the current-collecting foil to 10 μm or more makes it possible to inhibit the fracture of the positive electrode. On the other hand, bringing the thickness of the current-collecting foil to 100 μm or less makes it possible to enhance the energy density of the positive electrode.

Examples of methods of producing a positive electrode for lithium-ion battery include a method in which the current-collecting foil is coated with the positive electrode paste, which is then dried; and the like.

Examples of methods of coating the current-collecting foil with the positive electrode paste include a method in which a doctor blade, die coater, comma coater, spraying, or the like is used for the coating.

It is preferable that coating the current-collecting foil with the positive electrode paste according to the present invention is followed by a drying step in which the solvent is removed. A preferable method of removing a solvent is drying in an oven or a vacuum oven. Examples of atmospheres in which a solvent is removed include air, inert gas, a state of vacuum, and the like. In addition, a temperature at which the solvent is removed is preferably 60° C. or more and 250° C. or less.

In addition, it is preferable to have a step in which the current-collecting foil coated with the positive electrode paste is pressed to increase the density of the coating film after drying.

The amount of graphene contained in a positive electrode of a lithium-ion battery and the various properties and amount of the positive electrode active material can be measured as below-mentioned. First, a battery is disassembled in an Ar glove box, and the electrode is washed with dimethyl carbonate and vacuum-dried in a side box of the inert glove box for 1 hour. Next, a spatula is used to peel the positive electrode layer of a lithium-ion battery off from the current-collecting foil. The powdery positive electrode layer obtained is dissolved in a solvent such as N-methylpyrrolidone or water, and the resulting solution is filtrated to be separated into a residue (a positive electrode active material, an electroconductive additive, and a solvent) and a filtrate (a solvent and others). Drying the resulting filtrate, which is then redissolved in a deuterated solvent, followed by analyzing the resulting solution using an NMR, makes it possible to identify the binder. In addition, the resulting residue is dried to remove the solvent, and the weight is measured to determine the total weight of the positive electrode active material and the electroconductive additive. The composition ratio of the positive electrode active material in the resulting powder can be analyzed in the same manner as in the case of the above-mentioned positive electrode paste. Furthermore, acid such as hydrochloric acid or nitric acid is used to dissolve the positive electrode active material, and the resulting solution is filtrated to be separated into a residue (an electroconductive additive) and a filtrate (an electrode active material as a dissolved material, and water). The residue is washed with water, and then dried, and the weight is measured, whereby the amount of the electroconductive additive can be measured. In addition, the weight of the positive electrode active material can be determined from the total weight of the positive electrode active material and the electroconductive additive and the weight of the electroconductive additive. The resulting electroconductive additive can be analyzed in the same manner as the above-mentioned positive electrode paste.

### EXAMPLES

Below, the present invention will be described with reference to Examples. First, the evaluation methods in Examples and Comparative Examples will be described.

### Measurement Example 1: Thickness of Graphene

A graphene dispersion liquid produced in each of Examples and Comparative Examples was diluted to 0.002 weight % using N-methylpyrrolidone. In this case, a surface-treated graphene was treated using a “FILMIX” (registered trademark) model 30-30 (Primix Corporation) at a rotating speed of 40 m/s (a shear rate of 20000 per second) for 60 seconds. The diluted liquid was dropped onto a mica base plate, and dried to attach the graphene onto the base plate. The graphene on the base plate was magnified into an approximately 1 to 10 μm square field-of-view range using an atomic force microscope (Dimension Icon, from Bruker Corporation), and observed; 10 pieces of the graphene were randomly selected; and the thickness of each piece was measured. In this regard, the thickness of each piece of graphene was the arithmetic average of the values obtained by measuring the thicknesses of five points selected randomly from each piece of graphene. The thickness of the graphene was calculated by determining the arithmetic average of the thickness values of the 10 pieces of graphene. In this regard, the thickness of the graphene does not change in the graphene dispersion liquid, the positive electrode paste, or the positive electrode of a lithium-ion battery, and hence, was measured using only the graphene dispersion liquid.

### Measurement Example 2: Size of Graphene in Plane Direction Parallel to Graphene Layer

A graphene dispersion liquid produced in each of Examples and Comparative Examples was diluted to 0.002 weight % using N-methylpyrrolidone. In this case, a surface-treated graphene was treated using a “FILMIX” (registered trademark) model 30-30 (Primix Corporation) at a rotating speed of 40 m/s (a shear rate of 20000 per second) for 60 seconds. The diluted liquid was dropped onto a mica base plate, and dried to attach the graphene onto the base plate. The graphene on the base plate was magnified at a magnification ratio of 30,000× using an electron microscope S-5500 (manufactured by Hitachi High-Technologies Corporation), and observed; 10 pieces of the graphene were selected randomly; the length of the longest portion (major axis) and the length of the shortest portion (minor axis) in the plane direction parallel to the graphene layer were each measured; and the arithmetic average of the values was calculated in accordance with (the major axis+the minor axis)/2, whereby the size of the face parallel to the graphene layer was determined.

### Measurement Example 3: Measurement of O/C Ratio and N/C Ratio by X-ray Photoelectron Spectroscopy

The reduced surface-treated graphene dispersion liquid produced in each of Examples and Comparative Examples was filtrated with a suction filter, and then washed by repeating, five times, a washing step in which the liquid was diluted to 0.5 mass % with water, and suction-filtrated. The resulting solution was further freeze-dried to obtain surface-treated graphene powder. The resulting surface-treated graphene powder was subjected to photoelectron spectrum measurement using an X-ray photoelectron spectrometer Quantera SXM (manufactured by Physical Electronics, Inc.). Excited X-ray was monochromatic Al K_{α1,2} rays (1486.6 eV), the X-ray diameter was 200 μm, and the photoelectron take-off angle was 45°. A C1s main peak originating from carbon atoms was assigned to a peak near 284.3 eV, an O1s peak originating from oxygen atoms was assigned to a peak near 533 eV, an N1s peak originating from nitrogen atoms was assigned to a peak near 402 eV. The O/C ratio was calculated from the area ratio between the O1s peak and the C1s peak, and the calculated value was rounded off to two decimal places. In addition, the N/C ratio was calculated from the area ratio between the N1s peak and the C1s peak, and the calculated value was rounded off to three decimal places.

### Measurement Example 4: Viscosity of Graphene Dispersion Liquid

If needed, the graphene dispersion liquid produced in each of Examples and Comparative Examples was diluted by adding the same solvent as for the graphene dispersion liquid to the liquid, and mixing the resulting mixture using a rotary and revolutionary mixer at a rotating speed of 2000 rpm for 15 minutes in such a manner that the liquid had a graphene concentration of 3 weight %, and then, the viscosity was measured using a Brookfield viscometer LVDVII+ under conditions with rotor No. 6, at 1/s=10, and at 25° C.

### Measurement Example 5: Fluidity of Graphene Dispersion Liquid

One gram of the graphene dispersion liquid produced in each of Examples and Comparative Examples was dropped in the form of a circle having a diameter of approximately 1 cm onto one end of the non-glossy side of a clean and flat aluminum foil having a width of 5 cm and a length of 15 cm. That side of the aluminum foil on which the graphene dispersion liquid was placed was held and pulled up, whereby the aluminum foil was stood vertically. The aluminum foil was held without being vibrated, and left to stand for 10 minutes. The distance down which the graphene dispersion liquid dribbled by virtue of its own weight was measured. The distance down which the graphene dispersion liquid dribbled was measured as follows: with respect to the end of the graphene dispersion liquid in the direction of the gravity applied with the aluminum foil stood vertically, a measurement was taken of the distance between the end of the graphene dispersion liquid yet to dribble and the end of the liquid that dribbled. The graphene dispersion liquid that dribbled over a distance of 10 cm or more was rated A, 3 cm or more and less than 10 cm rated B, and less than 3 cm rated C.

### Measurement Example 6: Solid Content of Positive Electrode Paste

One gram of the positive electrode paste produced in each of Examples and Comparative Examples was weighed out, placed on a glass slide, and dried by heating in a vacuum oven at 120° C. for 5 hours. The weight after drying was measured, the measured value was divided by the weight before drying, the resulting value was rounded off to an integer, which was regarded as the solid content of the positive electrode paste.

### Measurement Example 7: Coating Film Uniformity

Using a doctor blade (300 μm), an aluminum foil (having a thickness of 18 μm) was coated with 5 g of the positive electrode paste produced in each of Examples and Comparative Examples. The paste was dried at 80° C. for 15 minutes, and then dried in vacuo at 120° C. for 2 hours to produce a coating film. The appearance of each of the ten places selected randomly from the coating film was examined so that visual observation could be performed on a range 1 cm square per place. The number of places at which defects such as thinned portions, cracks, defects in bubble form, and splinters were found on the coating film was ranked on the basis of the following indexes.

A: no defect was found at all. B: a defect(s) was/were found in one or two places. C: a defect(s) was/were found in three to five places. D: a defect(s) was/were found in six or more place.

### Measurement Example 8: Battery Life (Battery Capacity Maintenance Factor)

A 2032 type coin cell produced in each of Examples and Comparative Examples was subjected to a charge and discharge measurement at the upper limit voltage of 4.2 V and the lower limit voltage of 3.0 V and at a rate of 0.1 C, 1 C, and 5 C in this order, three times each, and then subjected to a further charge and discharge measurement at 2 C 291 times, a total of 300 times. The battery capacity for the 300th time was measured, and the ratio (percentage) thereof to the battery capacity for the first time was calculated, and was regarded as the battery capacity maintenance factor.

### Measurement Example 9: Loss Elastic Modulus and Storage Elastic Modulus

If needed, the graphene dispersion liquid produced in each of Examples and Comparative Examples was diluted by adding the same solvent as for the graphene dispersion liquid to the liquid, and mixing the resulting mixture using a rotary and revolutionary mixer at a rotating speed of 2000 rpm for 15 minutes in such a manner that the liquid had a graphene concentration of 3 weight %, and then, the liquid was subjected to measurement at a frequency of 10 Hz and at a temperature of 25° C. in a nitrogen stream using a viscoelasticity measurement device ARES-G2 (manufactured by TA Instruments, Inc.) with a parallel circular plate geometry having a diameter of 40 mm.

### Synthesis Example 1: Preparation of Graphene Oxide

A 1500 mesh natural graphite powder (Shanghai yifan's graphite Co., Ltd.) was used as a raw material. In an ice bath, 220 ml of 98% concentrated sulfuric acid, 5 g of sodium nitrate, and 30 g of potassium permanganate were added to 10 g of natural graphite powder, and the mixture was mechanically stirred for 1 hour with the temperature of the mixed solution maintained at 20° C. or less. The mixed solution was removed from the ice bath and stirred in a water bath at 35° C. for another 4 hours. Then, 500 ml of ion-exchanged water was added to the resulting solution, and the resulting suspension was stirred at 90° C. for another 15 minutes. Finally, 600 ml of ion-exchanged water and 50 ml of hydrogen peroxide were added to the resulting suspension, and the resulting mixture was stirred for 5 minutes to obtain a graphene oxide dispersion liquid. The resulting graphene oxide dispersion liquid was filtrated while still hot, the residue was washed with a diluted hydrochloric acid solution to remove metal ions, and then, the acid was washed with ion-exchanged water to remove the acid. Washing with ion-exchanged water was repeated until the pH became 7. Graphene oxide was thus prepared. The element ratio (O/C ratio) of oxygen atoms to carbon atoms in the graphene oxide prepared was 0.53 as measured by X-ray photoelectron spectroscopy.

### Synthesis Example 2: Preparation of Graphene Oxide

Graphene oxide was prepared in the same manner as in Synthesis Example 1 except that the 1500 mesh natural graphite powder (Shanghai yifan's graphite Co., Ltd.) was changed to AGB-32 (manufactured by Ito Graphite Co., Ltd.). The element ratio (O/C ratio) of oxygen atoms to carbon atoms in the graphene oxide prepared was 0.51 as measured by X-ray photoelectron spectroscopy.

### Example 1

(Preparation of Surface-Treated Graphene N-Methylpyrrolidone Dispersion Paste)

The graphene oxide prepared in Synthesis Example 1 was diluted to a concentration of 30 mg/ml using ion-exchanged water, treated using a homodisper model 2.5 (Primix Corporation) at a rotating speed of 3,000 rpm for 30 minutes to obtain a uniform graphene oxide dispersion liquid. The resulting graphene oxide dispersion liquid in an amount of 20 ml was mixed with 0.3 g of dopamine hydrochloride as a surface treatment agent, and the resulting mixture was treated using a homodisper model 2.5 (Primix Corporation) at a rotating speed of 3,000 rpm for 60 minutes. The graphene oxide dispersion liquid treated was subjected to ultrasonic waves using an ultrasonic apparatus UP400S (manufactured by Hielscher Ultrasonics GmbH) at an output of 300 W for 30 minutes (a comminuting step). The graphene oxide dispersion liquid that underwent the comminuting step was diluted to a concentration of 5 mg/ml using ion-exchanged water, 0.3 g of sodium dithionite was added to 20 ml of the dispersion liquid diluted, and the resulting mixture was stirred in a water bath using a homodisper model 2.5 (Primix Corporation) at a rotating speed of 3,000 rpm at 40° C. for 1 hour. Then, the resulting mixture was filtrated with a reduced-pressure suction filter, and then washed by repeating, five times, a washing step in which water was added to the residue, and then, the mixture was diluted to 0.5 weight %, and suction-filtrated, A graphene water dispersion liquid was thus obtained. N-methylpyrrolidone (hereinafter referred to as NMP) was added to the resulting graphene water dispersion liquid so that the graphene concentration could be 0.5 weight %. The resulting mixture was treated using a “FILMIX” (registered trademark) model 30-30 (Primix Corporation) at a rotating speed of 40 m/s (a shear rate of 20,000 per second) for 60 seconds. This treatment was followed by reduced-pressure suction filtration to remove the solvent. To further remove water, NMP was added to the residue so that the graphene concentration could become 0.5 weight %. The resulting mixture was diluted by treatment using a homodisper model 2.5 (Primix Corporation) at a rotating speed of 3000 rpm for 30 minutes. A step in which reduced-pressure suction filtration was performed until the filtrate dropped and disappeared was repeated twice, whereby an NMP dispersion paste containing 5.0 weight % of the surface-treated graphene was obtained as the residue.

(Preparation of Polyvinyl Alcohol Solution)

In a hermetically sealed container, 5 weight % of polyvinyl alcohol (manufactured by Fujifilm Wako Pure Chemical Corporation, having a saponification ratio of 88%, and having a polymerization degree of 500) was added to 95 weight % of NMP. The resulting mixture was heated to 90° C. under stirring with a magnetic stirrer, and the polyvinyl alcohol was thus dissolved completely to obtain an NMP solution of 5 weight % polyvinyl alcohol.

(Preparation of Graphene Dispersion Liquid)

To 20 g of NMP dispersion paste containing 5.0 weight % of the surface-treated graphene obtained as above-mentioned, 5 g of NMP solution of 5 weight % polyvinyl alcohol was added, and then, the resulting mixture was stirred using a “FILMIX” (registered trademark) model 30-30 (Primix Corporation) at a rotating speed of 40 m/s (a shear rate of 20,000 per second) for 15 minutes (a strong stirring step) to obtain a graphene dispersion liquid. The solid concentration of the resulting graphene dispersion liquid was 4 weight %, and the polyvinyl alcohol content was 25 parts by weight with respect to 100 parts by weight of the graphene.

The resulting graphene dispersion liquid was measured for the thickness of the graphene and the size of the graphene in the direction parallel to the graphene layer in accordance with Measurement Examples 1 and 2. In addition, the O/C ratio and the N/C ratio were measured in accordance with Measurement Example 3, and the viscosity of the graphene dispersion liquid was measured in accordance with Measurement Example 4. In addition, the fluidity of the graphene dispersion liquid was evaluated in accordance with Measurement Example 5, and the loss elastic modulus and storage elastic modulus of the graphene dispersion liquid were measured in accordance with Measurement Example 9. The results are shown in Table 3.

(Preparation of Positive Electrode Paste)

Using a rotary and revolutionary mixer, 20 g of LiNi_{0.5}Co_{0.2}Mn_{0.3}O₂ as a positive electrode active material, 5 g of 4 weight % graphene dispersion liquid as an electroconductive additive, and 2 g of NMP solution of 10 weight % PVDF as a binder were mixed at a rotating speed of 2000 rpm for 15 minutes. NMP was added to the resulting mixture. Here, the amount of NMP to be added was adjusted so that the viscosity of the mixture could become 2,000 mPa·s, as measured using a Brookfield viscometer LVDVII+ under conditions with rotor No. 6, at 60 rpm, and at 25° C. This mixture was mixed again using a rotary and revolutionary mixer at a rotating speed of 2,000 rpm for 15 minutes to obtain a positive electrode paste.

The resulting positive electrode paste was measured for the solid content of the positive electrode paste in accordance with Measurement Example 6, and the coating film uniformity was evaluated in accordance with Measurement Example 7. The results are shown in Table 3.

(Production of Coin Cell)

The resulting positive electrode paste was applied onto an aluminum foil (having a thickness of 18 μm) using a doctor blade so that the basis weight of the positive electrode paste after drying could be 18 mg/cm², was dried at 80° C. for 15 minutes, and then, was dried in vacuo at 120° C. for 2 hours to obtain an electrode plate.

The electrode plate produced was cut out in the form of a circle having a diameter of 15.9 mm, and used as a positive electrode. As a counter electrode, a coating film composed of 98 parts by weight of graphite, 1 part by weight of carboxymethyl cellulose sodium, and 1 part by weight of SBR water dispersion liquid was formed on a copper foil. The resulting piece was cut out in the form of a circle having a diameter of 16.1 mm, and used as a negative electrode. A CELGARD #2400 (manufactured by Celgard, LLC) cut out in the form of a circle having a diameter of 17 mm was used as a separator. A solvent containing ethylene carbonate and diethyl carbonate at 7:3 and containing 1 M LiPF₆ was used as an electrolyte solution. The separator and the electrolyte solution were sandwiched between the positive electrode and the negative electrode, and supplemented with 3 mL of the electrolyte solution. The resulting assembly was caulked to produce a 2032 type coin cell. The battery life (battery capacity maintenance factor) of the resulting coin cell was measured in accordance with Measurement Example 8.

### Example 2

A graphene dispersion liquid was obtained in the same manner as in Example 1 except that N,N-dimethylacetoamide was used instead of NMP in the preparation of the surface-treated graphene NMP dispersion paste, the preparation of the polyvinyl alcohol solution, and the preparation of the graphene dispersion liquid in Example 1. The resulting graphene dispersion liquid was used to produce a positive electrode paste and a 2032 type coin cell in the same manner as in Example 1.

### Example 3

A graphene dispersion liquid was obtained in the same manner as in Example 1 except that methylethylketone was used instead of NMP in the preparation of the surface-treated graphene NMP dispersion paste, the preparation of the polyvinyl alcohol solution, and the preparation of the graphene dispersion liquid in Example 1. The resulting graphene dispersion liquid was used to produce a positive electrode paste and a 2032 type coin cell in the same manner as in Example 1.

### Example 4

A graphene dispersion liquid was obtained in the same manner as in Example 1 except that cyclohexanone was used instead of NMP in the preparation of the surface-treated graphene NMP dispersion paste, the preparation of the polyvinyl alcohol solution, and the preparation of the graphene dispersion liquid in Example 1. The resulting graphene dispersion liquid was used to produce a positive electrode paste and a 2032 type coin cell in the same manner as in Example 1.

### Example 5

A graphene dispersion liquid was obtained in the same manner as in Example 1 except that nitromethane was used instead of NMP in the preparation of the surface-treated graphene NMP dispersion paste, the preparation of the polyvinyl alcohol solution, and the preparation of the graphene dispersion liquid in Example 1. The resulting graphene dispersion liquid was used to produce a positive electrode paste and a 2032 type coin cell in the same manner as in Example 1.

### Example 6

A graphene dispersion liquid was obtained in the same manner as in Example 1 except that the treatment time in the strong stirring step was prolonged to 30 minutes. The resulting graphene dispersion liquid was used to produce a positive electrode paste and a 2032 type coin cell in the same manner as in Example 1.

### Example 7

A graphene dispersion liquid was obtained in the same manner as in Example 1 except that the time for the strong stirring step was shortened to 5 minutes. The resulting graphene dispersion liquid was used to produce a positive electrode paste and a 2032 type coin cell in the same manner as in Example 1.

### Example 8

A graphene dispersion liquid was obtained in the same manner as in Example 1 except that the time for the comminuting step was prolonged to 120 minutes. The resulting graphene dispersion liquid was used to produce a positive electrode paste and a 2032 type coin cell in the same manner as in Example 1.

### Example 9

A graphene dispersion liquid was obtained in the same manner as in Example 1 except that the time for the comminuting step was prolonged to 90 minutes. The resulting graphene dispersion liquid was used to produce a positive electrode paste and a 2032 type coin cell in the same manner as in Example 1.

### Example 10

A graphene dispersion liquid was obtained in the same manner as in Example 1 except that the time for the comminuting step was shortened to 10 minutes. The resulting graphene dispersion liquid was used to produce a positive electrode paste and a 2032 type coin cell in the same manner as in Example 1.

### Example 11

A graphene dispersion liquid was obtained in the same manner as in Example 1 except that the graphene oxide prepared in Synthesis Example 2 was used instead of the graphene oxide prepared in Synthesis Example 1, and that the comminuting step was not performed. The resulting graphene dispersion liquid was used to produce a positive electrode paste and a 2032 type coin cell in the same manner as in Example 1.

### Example 12

A graphene dispersion liquid was obtained in the same manner as in Example 1 except that the amount of sodium dithionite used was decreased to 0.1 g. The resulting graphene dispersion liquid was used to produce a positive electrode paste and a 2032 type coin cell in the same manner as in Example 1.

### Example 13

A graphene dispersion liquid was obtained in the same manner as in Example 1 except that the amount of sodium dithionite used was decreased to 0.05 g. The resulting graphene dispersion liquid was used to produce a positive electrode paste and a 2032 type coin cell in the same manner as in Example 1.

### Example 14

A graphene dispersion liquid was obtained in the same manner as in Example 1 except that the amount of sodium dithionite used was decreased to 0.01 g. The resulting graphene dispersion liquid was used to produce a positive electrode paste and a 2032 type coin cell in the same manner as in Example 1.

### Example 15

A graphene dispersion liquid was obtained in the same manner as in Example 1 except that the dopamine hydrochloride was changed to catechol. The resulting graphene dispersion liquid was used to produce a positive electrode paste and a 2032 type coin cell in the same manner as in Example 1.

### Example 16

A graphene dispersion liquid was obtained in the same manner as in Example 1 except that the dopamine hydrochloride was changed to benzylamine hydrochloride, and that the usage amount was decreased to 0.1 g. The resulting graphene dispersion liquid was used to produce a positive electrode paste and a 2032 type coin cell in the same manner as in Example 1.

### Example 17

A graphene dispersion liquid was obtained in the same manner as in Example 1 except that the dopamine hydrochloride was changed to phenylethylamine hydrochloride, and that the usage amount was decreased to 0.2 g. The resulting graphene dispersion liquid was used to produce a positive electrode paste and a 2032 type coin cell in the same manner as in Example 1.

### Example 18

A graphene dispersion liquid was obtained in the same manner as in Example 1 except that the amount of the dopamine hydrochloride used in Example 1 was increased to 0.7 g. The resulting graphene dispersion liquid was used to produce a positive electrode paste and a 2032 type coin cell in the same manner as in Example 1.

### Example 19

A graphene dispersion liquid was obtained in the same manner as in Example 1 except that, in the preparation of the graphene dispersion liquid, 2 g of the NMP solution of 5 weight % polyvinyl alcohol was added to 20 g of the NMP dispersion paste containing 5.0 weight % of the surface-treated graphene, and then, 3 g of NMP was added to the resulting mixture. The resulting graphene dispersion liquid was used to produce a positive electrode paste and a 2032 type coin cell in the same manner as in Example 1.

### Example 20

A graphene dispersion liquid was prepared in the same manner as in Example 1.

In the preparation of a polyvinyl alcohol solution, 4 g of polyvinyl alcohol and 16 g of NMP were heated to 90° C. under stirring in a hermetically sealed container using a magnetic stirrer, and the polyvinyl alcohol was partially dissolved to obtain a mixture of 20 weight % polyvinyl alcohol and NMP.

In the preparation of a graphene dispersion liquid, 20 g of the NMP dispersion paste containing 5.0 weight % of the surface-treated graphene was added to 5 g of the resulting mixture of 20 weight % polyvinyl alcohol and NMP. The resulting mixture was heated again at 90° C. for 8 hours. Then, the whole mixture was well mixed using a spatula, and treated using a “FILMIX” (registered trademark) model 30-30 (Primix Corporation) at a rotating speed of 40 m/s (a shear rate of 20,000 per second) for 60 minutes to obtain a graphene dispersion liquid. The resulting graphene dispersion liquid was used to produce a positive electrode paste and a 2032 type coin cell in the same manner as in Example 1.

### Example 21

A graphene dispersion liquid was prepared in the same manner as in Example 1.

In the preparation of a polyvinyl alcohol solution, 10 g of polyvinyl alcohol and 10 g of NMP were heated to 90° C. under stirring in a hermetically sealed container using a magnetic stirrer, and the polyvinyl alcohol was partially dissolved to obtain a mixture of 50 weight % polyvinyl alcohol and NMP.

In the preparation of a graphene dispersion liquid, 20 g of the NMP dispersion paste containing 5.0 weight % of the surface-treated graphene was added to 5 g of the resulting mixture of 50 weight % polyvinyl alcohol and NMP. The resulting mixture was heated again at 90° C. for 8 hours. Then, the whole mixture was well mixed using a spatula, and treated using a “FILMIX” (registered trademark) model 30-30 (Primix Corporation) at a rotating speed of 40 m/s (a shear rate of 20,000 per second) for 60 minutes to obtain a graphene dispersion liquid. The resulting graphene dispersion liquid was used to produce a positive electrode paste and a 2032 type coin cell in the same manner as in Example 1.

### Example 22

A graphene dispersion liquid was obtained in the same manner as in Example 1 except that, in the preparation of the polyvinyl alcohol, the polyvinyl alcohol was changed to a polyvinyl alcohol having a saponification ratio of 75% and a polymerization degree of 500 (manufactured by Fujifilm Wako Pure Chemical Corporation). The resulting graphene dispersion liquid was used to produce a positive electrode paste and a 2032 type coin cell in the same manner as in Example 1.

### Example 23

A graphene dispersion liquid was obtained in the same manner as in Example 1 except that, in the preparation of the polyvinyl alcohol, the polyvinyl alcohol was changed to a polyvinyl alcohol having a saponification ratio of 98% and a polymerization degree of 500 (manufactured by Fujifilm Wako Pure Chemical Corporation). The resulting graphene dispersion liquid was used to produce a positive electrode paste and a 2032 type coin cell in the same manner as in Example 1.

### Example 24

A graphene dispersion liquid was obtained in the same manner as in Example 1 except that, in the preparation of the polyvinyl alcohol, the polyvinyl alcohol was changed to a polyvinyl alcohol having a saponification ratio of 88% and a polymerization degree of 1500 (manufactured by Fujifilm Wako Pure Chemical Corporation). The resulting graphene dispersion liquid was used to produce a positive electrode paste and a 2032 type coin cell in the same manner as in Example 1.

### Example 25

A graphene dispersion liquid was obtained in the same manner as in Example 1 except that, in the preparation of the polyvinyl alcohol, the polyvinyl alcohol was changed to a polyvinyl alcohol having a saponification ratio of 88% and a polymerization degree of 3500 (manufactured by Fujifilm Wako Pure Chemical Corporation). The resulting graphene dispersion liquid was used to produce a positive electrode paste and a 2032 type coin cell in the same manner as in Example 1.

### Example 26

A polyvinyl alcohol solution was obtained in the same manner as in Example 1 except that, in the preparation of the polyvinyl alcohol, the polyvinyl alcohol was changed to a polyvinyl alcohol having a saponification ratio of 94.2% and a polymerization degree of 500 (tradename “JT-05” manufactured by Japan VAM & POVAL Co., Ltd.). Additionally, in the preparation of the graphene dispersion liquid, 5 g of the NMP solution of 5 weight % polyvinyl alcohol was added to 20 g of the NMP dispersion paste containing 5.0 weight % of the surface-treated graphene. Then, the resulting mixture was stirred using an “AWATORI RENTARO” (registered trademark) ARE-310 (manufactured by Thinky Corporation) at a rotating speed of 2000 rpm for 15 minutes to obtain a graphene dispersion liquid. The resulting graphene dispersion liquid was used to produce a positive electrode paste and a 2032 type coin cell in the same manner as in Example 1.

### Example 27

A polyvinyl alcohol solution was obtained in the same manner as in Example 1 except that, in the preparation of the polyvinyl alcohol, the polyvinyl alcohol was changed to a modified polyvinyl alcohol containing a sulfate group and having a saponification ratio of 87.8% and a polymerization degree of 200 (tradename “GOHSENX” (registered trademark) L-3266, manufactured by Mitsubishi Chemical Corporation). Using the resulting polyvinyl alcohol, a graphene dispersion liquid was obtained in the same manner as in Example 26. The resulting graphene dispersion liquid was used to produce a positive electrode paste and a 2032 type coin cell in the same manner as in Example 1.

### Example 28

A graphene dispersion liquid was obtained in the same manner as in Example 1 except that the polyvinyl alcohol was changed to polyvinylpyrrolidone K-60 (manufactured by Tokyo Chemical Industry Co., Ltd.). The resulting graphene dispersion liquid was used to produce a positive electrode paste and a 2032 type coin cell in the same manner as in Example 1.

### Example 29

A graphene dispersion liquid was obtained in the same manner as in Example 1 except that the polyvinyl alcohol was changed to hydroxypropyl cellulose (manufactured by Sigma-Aldrich, having a mass-average molecular weight (Mw) of 80,000). The resulting graphene dispersion liquid was used to produce a positive electrode paste and a 2032 type coin cell in the same manner as in Example 1.

### Example 30

A graphene dispersion liquid was obtained in the same manner as in Example 1 except that, in the preparation of the graphene dispersion liquid, 1 g of NMP solution of 5 weight % polyvinyl alcohol was added to 20 g of NMP dispersion paste containing 5.0 weight % of the surface-treated graphene, 12.3 g of NMP was added, and then, the resulting mixture was stirred using a “FILMIX” (registered trademark) model 30-30 (Primix Corporation) at a rotating speed of 40 m/s (a shear rate of 20,000 per second) for 30 minutes (a strong stirring step). The resulting graphene dispersion liquid was used to produce a positive electrode paste and a 2032 type coin cell in the same manner as in Example 1.

### Comparative Example 1

A graphene dispersion liquid was obtained in the same manner as in Example 1 except that no polyvinyl alcohol was used. The resulting graphene dispersion liquid was used to produce a positive electrode paste and a 2032 type coin cell in the same manner as in Example 1.

### Comparative Example 2

A graphene dispersion liquid was obtained in the same manner as in Example 1 except that the polyvinyl alcohol was changed to polyvinylpyrrolidone K-60 (manufactured by Tokyo Chemical Industry Co., Ltd.), and that, in the preparation of the graphene dispersion liquid, the resulting mixture was stirred using a “FILMIX” (registered trademark) model 30-30 (Primix Corporation) at a rotating speed of 40 m/s (a shear rate of 20,000 per second) for 10 seconds. The resulting graphene dispersion liquid was used to produce a positive electrode paste and a 2032 type coin cell in the same manner as in Example 1.

### Comparative Example 3

A graphene dispersion liquid was obtained in the same manner as in Example 30 except that, in the preparation of the graphene dispersion liquid, the treatment time in the strong stirring step was changed to 15 minutes. The resulting graphene dispersion liquid was used to produce a positive electrode paste and a 2032 type coin cell in the same manner as in Example 1.

### Comparative Example 4

A graphene dispersion liquid was obtained in the same manner as in Example 1 except that, in the preparation of the graphene dispersion liquid, the strong stirring step was not performed. The resulting graphene dispersion liquid was used to produce a positive electrode paste and a 2032 type coin cell in the same manner as in Example 1.

### Comparative Example 5

A graphene dispersion liquid was obtained in the same manner as in Example 1 except that isobutyl acetate was used instead of NMP in the preparation of the surface-treated graphene NMP dispersion paste and the preparation of the graphene dispersion liquid in Comparative Example 1. The resulting graphene dispersion liquid was used to produce a positive electrode paste and a 2032 type coin cell in the same manner as in Example 1.

### Comparative Example 6

A graphene dispersion liquid was obtained in the same manner as in Example 1 except that ethylene glycol was used instead of NMP in the preparation of the surface-treated graphene NMP dispersion paste and the preparation of the graphene dispersion liquid in Comparative Example 1. The resulting graphene dispersion liquid was used to produce a positive electrode paste and a 2032 type coin cell in the same manner as in Example 1.

### Comparative Example 7

A graphene dispersion liquid was obtained in the same manner as in Example 1 except that, in the preparation of the surface-treated graphene NMP dispersion paste in Example 1, the graphene water dispersion liquid was replaced with a liquid that was obtained by diluting graphite nanoplatelets (model number M-5, manufactured by XG Sciences, Inc.) to a concentration of 0.5 weight % using ion-exchanged water, and then by treating the resulting diluted liquid using a homodisper model 2.5 (Primix Corporation) at a rotating speed of 3,000 rpm for 30 minutes. The resulting graphene dispersion liquid was used to produce a positive electrode paste and a 2032 type coin cell in the same manner as in Example 1.

The compositions in Examples and Comparative Examples are shown in Tables 1 to 3, and the evaluation results are shown in Tables 4 and 5.

TABLE 1
dispersion liquid

| | Graphene dispersion liquid | | | | |
|---|---|---|---|---|---|
| | Graphene | | | | |
| | Average | Size in direction parallel | | | |
| | thickness | to graphene layer | | | |
| | (nm) | (μm) | O/C ratio | N/C ratio | Surface treatment agent |
| Example 1 | 2.1 | 10 | 0.13 | 0.014 | dopamine hydrochloride |
| Example 2 | 2.1 | 10 | 0.13 | 0.014 | dopamine hydrochloride |
| Example 3 | 2.1 | 10 | 0.13 | 0.014 | dopamine hydrochloride |
| Example 4 | 2.1 | 10 | 0.13 | 0.014 | dopamine hydrochloride |
| Example 5 | 2.1 | 10 | 0.13 | 0.014 | dopamine hydrochloride |
| Example 6 | 1.0 | 3 | 0.15 | 0.013 | dopamine hydrochloride |
| Example 7 | 7.8 | 3 | 0.09 | 0.015 | dopamine hydrochloride |
| Example 8 | 1.0 | 0.3 | 0.13 | 0.010 | dopamine hydrochloride |
| Example 9 | 2.1 | 0.5 | 0.13 | 0.014 | dopamine hydrochloride |
| Example 10 | 2.1 | 80 | 0.13 | 0.014 | dopamine hydrochloride |
| Example 11 | 9.6 | 200 | 0.09 | 0.016 | dopamine hydrochloride |
| Example 12 | 2.1 | 10 | 0.22 | 0.013 | dopamine hydrochloride |
| Example 13 | 2.1 | 10 | 0.33 | 0.013 | dopamine hydrochloride |
| Example 14 | 2.1 | 10 | 0.42 | 0.013 | dopamine hydrochloride |
| Example 15 | 2.1 | 10 | 0.15 | 0.000 | catechol |

| | Graphene dispersion liquid | | | | | Positive |
|---|---|---|---|---|---|---|
| | Polyvinyl alcohol | | | | | electrode |
| | | Saponi- | | Solvent | | paste |
| | Content*¹ | fication | Polymer- | | Solubility | Solid |
| | (part(s) | ratio | ization | | parameter δ | content |
| | by weight) | (%) | degree | Solvent | (MPa^{0.5}) | (weight %) |
| Example 1 | 25 | 88 | 500 | N-methylpyrrolidone | 23.1 | 74 |
| Example 2 | 25 | 88 | 500 | N,N-dimethylacetoamide | 22.1 | 73 |
| Example 3 | 25 | 88 | 500 | methylethylketone | 19.0 | 70 |
| Example 4 | 25 | 88 | 500 | cyclohexanone | 20.3 | 71 |
| Example 5 | 25 | 88 | 500 | nitromethane | 26.0 | 71 |
| Example 6 | 25 | 88 | 500 | N-methylpyrrolidone | 23.1 | 74 |
| Example 7 | 25 | 88 | 500 | N-methylpyrrolidone | 23.1 | 71 |
| Example 8 | 25 | 88 | 500 | N-methylpyrrolidone | 23.1 | 72 |
| Example 9 | 25 | 88 | 500 | N-methylpyrrolidone | 23.1 | 73 |
| Example 10 | 25 | 88 | 500 | N-methylpyrrolidone | 23.1 | 71 |
| Example 11 | 25 | 88 | 500 | N-methylpyrrolidone | 23.1 | 70 |
| Example 12 | 25 | 88 | 500 | N-methylpyrrolidone | 23.1 | 74 |
| Example 13 | 25 | 88 | 500 | N-methylpyrrolidone | 23.1 | 73 |
| Example 14 | 25 | 88 | 500 | N-methylpyrrolidone | 23.1 | 72 |
| Example 15 | 25 | 88 | 500 | N-methylpyrrolidone | 23.1 | 70 |

*¹part(s) by weight with respect to 100 parts by weight of graphene

TABLE 2

| | Graphene dispersion liquid | | | | |
|---|---|---|---|---|---|
| | Graphene | | | | |
| | Average | Size in direction parallel | | | |
| | thickness | to graphene layer | | | |
| | (nm) | (μm) | O/C ratio | N/C ratio | Surface treatment agent |
| Example 16 | 2.1 | 10 | 0.13 | 0.004 | benzylamine hydrochloride |
| Example 17 | 2.1 | 10 | 0.13 | 0.009 | phenylethylamine hydrochloride |
| Example 18 | 2.1 | 10 | 0.13 | 0.031 | dopamine hydrochloride |
| Example 19 | 2.1 | 10 | 0.13 | 0.014 | dopamine hydrochloride |
| Example 20 | 2.1 | 10 | 0.13 | 0.014 | dopamine hydrochloride |
| Example 21 | 2.1 | 10 | 0.13 | 0.014 | dopamine hydrochloride |
| Example 22 | 2.1 | 10 | 0.13 | 0.014 | dopamine hydrochloride |
| Example 23 | 2.1 | 10 | 0.13 | 0.014 | dopamine hydrochloride |
| Example 24 | 2.1 | 10 | 0.13 | 0.014 | dopamine hydrochloride |
| Example 25 | 2.1 | 10 | 0.13 | 0.014 | dopamine hydrochloride |
| Example 26 | 2.1 | 10 | 0.13 | 0.014 | dopamine hydrochloride |
| Example 27 | 2.1 | 10 | 0.13 | 0.014 | dopamine hydrochloride |
| Example 28 | 2.1 | 10 | 0.13 | 0.014 | dopamine hydrochloride |
| Example 29 | 2.1 | 10 | 0.13 | 0.014 | dopamine hydrochloride |
| Example 30 | 2.1 | 10 | 0.13 | 0.014 | dopamine hydrochloride |

| | Graphene dispersion liquid | | | | | Positive |
|---|---|---|---|---|---|---|
| | Polyvinyl alcohol | | | | | electrode |
| | | Saponi- | | Solvent | | paste |
| | Content*1 | fication | Polymer- | | Solubility | Solid |
| | (part(s) | ratio | ization | | parameter δ | content |
| | by weight) | (%) | degree | Solvent | (MPa^{0.5}) | (weight %) |
| Example 16 | 25 | 88 | 500 | N-methylpyrrolidone | 23.1 | 71 |
| Example 17 | 25 | 88 | 500 | N-methylpyrrolidone | 23.1 | 73 |
| Example 18 | 25 | 88 | 500 | N-methylpyrrolidone | 23.1 | 71 |
| Example 19 | 10 | 88 | 500 | N-methylpyrrolidone | 23.1 | 71 |
| Example 20 | 100 | 88 | 500 | N-methylpyrrolidone | 23.1 | 74 |
| Example 21 | 250 | 88 | 500 | N-methylpyrrolidone | 23.1 | 73 |
| Example 22 | 25 | 75 | 500 | N-methylpyrrolidone | 23.1 | 71 |
| Example 23 | 25 | 98 | 500 | N-methylpyrrolidone | 23.1 | 74 |
| Example 24 | 25 | 88 | 1500 | N-methylpyrrolidone | 23.1 | 72 |
| Example 25 | 25 | 88 | 3500 | N-methylpyrrolidone | 23.1 | 70 |
| Example 26 | 10 | 94.2 | 500 | N-methylpyrrolidone | 23.1 | 70 |
| Example 27 | 10 | 87.8 | 200 | N-methylpyrrolidone | 23.1 | 71 |
| Example 28 | 25 | polyvinylpyrrolidone | | N-methylpyrrolidone | 23.1 | 69 |
| Example 29 | 25 | hydroxypropyl cellulose | | N-methylpyrrolidone | 23.1 | 68 |
| Example 30 | 5 | 88 | 500 | N-methylpyrrolidone | 23.1 | 69 |

*¹part(s) by weight with respect to 100 parts by weight of graphene

TABLE 3

| | Graphene dispersion liquid | | | | |
|---|---|---|---|---|---|
| | Graphene | | | | |
| | Average | Size in direction parallel | | | |
| | thickness | to graphene layer | | | |
| | (nm) | (μm) | O/C ratio | N/C ratio | Surface treatment agent |
| Comparative | 2.1 | 10 | 0.13 | 0.014 | dopamine hydrochloride |
| Example 1 | | | | | |
| Comparative | 2.1 | 10 | 0.13 | 0.014 | dopamine hydrochloride |
| Example 2 | | | | | |
| Comparative | 2.1 | 10 | 0.13 | 0.014 | dopamine hydrochloride |
| Example 3 | | | | | |
| Comparative | 15 | 3 | 0.09 | 0.015 | dopamine hydrochloride |
| Example 4 | | | | | |
| Comparative | 2.1 | 10 | 0.13 | 0.014 | dopamine hydrochloride |
| Example 5 | | | | | |
| Comparative | 2.1 | 10 | 0.13 | 0.014 | dopamine hydrochloride |
| Example 6 | | | | | |
| Comparative | 20 | 10 | 0.03 | 0 | none |
| Example 7 | | | | | |

| | Graphene dispersion liquid | | | | | Positive |
|---|---|---|---|---|---|---|
| | Polyvinyl alcohol | | | | | electrode |
| | | Saponi- | | Solvent | | paste |
| | Content*¹ | fication | Polymer- | | Solubility | Solid |
| | (part(s) | ratio | ization | | parameter δ | content |
| | by weight) | (%) | degree | Solvent | (MPa^{0.5}) | (weight %) |
| Comparative | 0 | — | — | N-methylpyrrolidone | 23.1 | 65 |
| Example 1 | | | | | | |
| Comparative | 25 | polyvinylpyrrolidone | | N-methylpyrrolidone | 23.1 | 65 |
| Example 2 | | | | | | |
| Comparative | 5 | 88 | 500 | N-methylpyrrolidone | 23.1 | 67 |
| Example 3 | | | | | | |
| Comparative | 25 | 88 | 500 | N-methylpyrrolidone | 23.1 | 74 |
| Example 4 | | | | | | |
| Comparative | 0 | — | — | isobutyl acetate | 17.0 | 66 |
| Example 5 | | | | | | |
| Comparative | 0) | — | — | ethylene glycol | 29.9 | 64 |
| Example 6 | | | | | | |
| Comparative | 25 | 88 | 500 | N-methylpyrrolidone | 23.1 | 74 |
| Example 7 | | | | | | |

*¹part(s) by weight with respect to 100 parts by weight of graphene

TABLE 4

| | Evaluation results | | | | | | | |
|---|---|---|---|---|---|---|---|---|
| | | | | | | | Positive | Positive electrode of |
| | Graphene dispersion liquid | | | | | | electrode | lithium-ion battery |
| | | | Storage | Loss | | | paste | Battery life: |
| | | | elastic | elastic | | | Coating | battery capacity |
| | Viscosity*² | | modulus*³ | modulus*³ | | | film | maintenance factor |
| | (mPa · s) | Fluidity | (Pa) | (Pa) | G′₂₀₀/G′₁₀*⁴ | G″₂₀₀/G″₁₀*⁵ | uniformity | (%) |
| Example 1 | 600 | A | 2.1 | 2.3 | 96 | 169 | A | 85 |
| Example 2 | 1500 | A | 5.5 | 4.9 | 88 | 155 | A | 82 |
| Example 3 | 2400 | A | 44 | 54 | 50 | 68 | B | 81 |
| Example 4 | 4000 | B | 89 | 94 | 14 | 12 | B | 79 |
| Example 5 | 3400 | A | 63 | 71 | 33 | 35 | B | 80 |
| Example 6 | 1800 | A | 2.4 | 3.1 | 88 | 150 | A | 83 |
| Example 7 | 800 | A | 3.2 | 4.1 | 83 | 175 | B | 78 |
| Example 8 | 1300 | A | 2.5 | 2.1 | 88 | 150 | B | 82 |
| Example 9 | 1000 | A | 2.3 | 2.2 | 95 | 155 | A | 83 |
| Example 10 | 2600 | A | 91 | 88 | 51 | 58 | B | 81 |
| Example 11 | 4800 | A | 143 | 134 | 43 | 54 | B | 78 |
| Example 12 | 3500 | A | 2.2 | 2.3 | 94 | 150 | A | 79 |
| Example 13 | 4000 | A | 2.4 | 2.2 | 91 | 167 | A | 75 |
| Example 14 | 6500 | B | 77 | 82 | 32 | 43 | B | 71 |
| Example 15 | 5400 | B | 3.5 | 3.9 | 82 | 143 | B | 72 |
| Example 16 | 1900 | A | 2.2 | 2.9 | 85 | 169 | B | 79 |
| Example 17 | 1000 | A | 2.1 | 2.5 | 101 | 180 | A | 82 |
| Example 18 | 4700 | B | 143 | 122 | 5.4 | 6.5 | B | 79 |
| Example 19 | 7000 | B | 280 | 190 | 1.8 | 1.5 | B | 79 |

*²A viscosity at a graphene concentration adjusted to 3 weight %, at a shear rate of 10 sec⁻¹, and at a temperature of 25° C.
*³A storage elastic modulus and a loss elastic modulus at a graphene concentration adjusted to 3 weight % , at a strain of 10%, at a frequency of 10 Hz, and at a temperature of 25° C.
*⁴G′₂₀₀ represents a storage elastic modulus at a strain of 200%, and G′₁₀ represents a storage elastic modulus at a strain of 10%.
*⁵G″₂₀₀ represents a loss elastic modulus at a strain of 200%, and G″₁₀ represents a loss elastic modulus at a strain of 10%.

TABLE 5

| | Evaluation results | | | | | | | |
|---|---|---|---|---|---|---|---|---|
| | | | | | | | Positive | Positive electrode of |
| | Graphene dispersion liquid | | | | | | electrode | lithium-ion battery |
| | | | Storage | Loss | | | paste | Battery life: |
| | | | elastic | elastic | | | Coating | battery capacity |
| | Viscosity*² | | modulus*³ | modulus*³ | | | film | maintenance factor |
| | (mPa · s) | Fluidity | (Pa) | (Pa) | G′₂₀₀/G′₁₀*⁴ | G″₂₀₀/G″′₁₀*⁵ | uniformity | (%) |
| Example 20 | 1200 | A | 1.9 | 2.5 | 97 | 168 | A | 83 |
| Example 21 | 700 | A | 1.9 | 2.4 | 98 | 171 | A | 78 |
| Example 22 | 3700 | B | 22 | 36 | 54 | 114 | A | 80 |
| Example 23 | 700 | A | 1.8 | 2.1 | 97 | 170 | A | 83 |
| Example 24 | 1000 | A | 31 | 28 | 103 | 145 | A | 82 |
| Example 25 | 5100 | B | 326 | 343 | 7.9 | 8.1 | A | 80 |
| Example 26 | 900 | B | 134 | 225 | 2.1 | 1.8 | B | 84 |
| Example 27 | 800 | B | 0.9 | 0.8 | 98 | 103 | A | 84 |
| Example 28 | 3900 | B | 680 | 1200 | 0.06 | 0.07 | B | 75 |
| Example 29 | 4600 | B | 730 | 870 | 0.4 | 0.4 | B | 72 |
| Example 30 | 7000 | B | 520 | 420 | 2.2 | 1.9 | B | 70 |
| Comparative Example 1 | >10000 | C | 31600 | 57900 | 0.04 | 0.07 | D | 40 |
| Comparative Example 2 | >10000 | C | 42000 | 54000 | 0.06 | 0.08 | C | 55 |
| Comparative Example 3 | >10000 | C | 20000 | 26000 | 0.1 | 0.2 | C | 55 |
| Comparative Example 4 | 1100 | A | 189 | 203 | 0.9 | 0.9 | D | 30 |
| Comparative Example 5 | >10000 | C | 59000 | 68000 | 0.04 | 0.05 | D | 24 |
| Comparative Example 6 | >10000 | C | 86000 | 99000 | 0.03 | 0.02 | D | 25 |
| Comparative Example 7 | 800 | A | 1.8 | 1.3 | 0.8 | 0.8 | D | 25 |

*²A viscosity at a graphene concentration adjusted to 3 weight %, at a shear rate of 10 sec⁻¹, and at a temperature of 25° C.
*³A storage elastic modulus and a loss elastic modulus at a graphene concentration adjusted to 3 weight % , at a strain of 10%, at a frequency of 10 Hz, and at a temperature of 25° C.
*⁴G′₂₀₀ represents a storage elastic modulus at a strain of 200%, and G′₁₀ represents a storage elastic modulus at a strain of 10%.
*⁵G″₂₀₀ represents a loss elastic modulus at a strain of 200%, and G″₁₀ represents a loss elastic modulus at a strain of 10%.

1. A graphene dispersion liquid comprising graphene and a solvent,
wherein the graphene has an average thickness of 0.3 nm or more and 10 nm or less,
wherein the solvent has a solubility parameter δ of 18 MPa^{0.5} or more and 28 MPa^{0.5} or less, and
wherein the graphene dispersion liquid has a viscosity of 10,000 mPa·s or less at a graphene concentration adjusted to 3 weight %, at a shear rate of 10 sec⁻¹, and at a temperature of 25° C.

2. The graphene dispersion liquid according to claim 1, having a viscosity of 10 mPa·s or more and 1,000 mPa·s or less at a graphene concentration adjusted to 3 weight %, at a shear rate of 10 sec⁻¹, and at a temperature of 25° C.

3. The graphene dispersion liquid according to claim 1, having a storage elastic modulus and a loss elastic modulus that are each 0.1 Pa or more and 100 Pa or less at a graphene concentration adjusted to 3 weight %, at a strain of 10%, at a frequency of 10 Hz, and at a temperature of 25° C.

4. The graphene dispersion liquid according to claim 1, having a storage elastic modulus and a loss elastic modulus that each satisfy the following formula (1) and/or formula (2) at a graphene concentration adjusted to 3 weight %, at a frequency of 10 Hz, and at a temperature of 25° C.:
G′₂₀₀/G′₁₀≥1 Formula (1):
wherein, in formula (1), G′₂₀₀ represents a storage elastic modulus at a strain of 200%, and G′₁₀ represents a storage elastic modulus at a strain of 10%;
G″₂₀₀/G″₁₀≥1 Formula (2):
wherein, in formula (2), G″₂₀₀ represents a loss elastic modulus at a strain of 200%, and G″₁₀ represents a loss elastic modulus at a strain of 10%.

5. The graphene dispersion liquid according to claim 1, wherein the element ratio of oxygen to carbon (O/C ratio) in the graphene is 0.05 or more and 0.35 or less, as measured by X-ray photoelectron spectroscopy.

6. The graphene dispersion liquid according to claim 1, wherein the element ratio of nitrogen to carbon (N/C ratio) in the graphene is 0.005 or more and 0.020 or less, as measured by X-ray photoelectron spectroscopy.

7. The graphene dispersion liquid according to claim 1, wherein the dispersion liquid further contains a polymer selected from polyvinyl alcohol, polyvinylpyrrolidone, and hydroxypropyl cellulose.

8. The graphene dispersion liquid according to claim 7, wherein the polyvinyl alcohol has a saponification ratio of 70% or more and 100% or less.

9. The graphene dispersion liquid according to claim 7, comprising 1 part by weight or more and 300 parts by weight or less of the polyvinyl alcohol with respect to 100 parts by weight of the graphene.

10. The graphene dispersion liquid according to claim 1, wherein the solvent contains a solvent selected from N,N-dimethylformamide, N-methylpyrrolidone, and N,N-dimethylacetoamide.

11. A positive electrode paste comprising the graphene dispersion liquid according to claim 1 and a positive electrode active material.

12. The positive electrode paste according to claim 11, comprising 0.05 part by weight or more and 2.5 parts by weight or less of the graphene having an average thickness of 0.3 nm or more and 10 nm or less with respect to 100 parts by weight of the positive electrode active material.
